(19) United States
(12) Patent Application Publication
(10) Pub. No.: US 2025/0037479 A1
(43) Pub. Date: Jan. 30, 2025

(54) WEARABLE ELECTRONIC DEVICE FOR DISPLAYING VIRTUAL OBJECT, AND OPERATING METHOD THEREOF

(71) Applicant: Samsung Electronics Co., Ltd., Suwon-si (KR)

(72) Inventors: Choonkyoung MOON, Suwon-si (KR); Doosuk KANG, Suwon-si (KR); Hyunkee MIN, Suwon-si (KR); Mingyu LEE, Suwon-si (KR); Bokun CHOI, Suwon-si (KR)

(21) Appl. No.: 18/784,179

(22) Filed: Jul. 25, 2024

Related U.S. Application Data
(63) Continuation of application No. PCT/KR2024/010429, filed on Jul. 19, 2024.

(30) Foreign Application Priority Data
Jul. 27, 2023 (KR) 10-2023-0098067
Oct. 31, 2023 (KR) 10-2023-0148535

(51) Int. Cl. G06V 20/59; G06F 1/16; G06F 3/01; G06V 40/20

(52) U.S. Cl. CPC G06V 20/597; G06F 1/163; G06F 3/013; G06V 40/20

(57) ABSTRACT

According to an embodiment, a wearable electronic device may include a camera, a display, communication circuitry, and a processor, wherein the processor may establish a communication connection with a control device included in a vehicle through the communication circuitry, identify the state of a user in the vehicle through the camera, identify a driving state of the vehicle, determine at least one area for identifying a gesture of the user, based on at least one of the state of the user or the driving state, and execute a first function corresponding to a first gesture among at least one function, based on identifying the first gesture of the user in the at least one area.

### CROSS-REFERENCE TO RELATED APPLICATION(S)

This application is a continuation application, claiming priority under § 365(c), of an International application No. PCT/KR2024/010429, filed on Jul. 19, 2024, which is based on and claims the benefit of a Korean patent application number 10-2023-0098067, filed on Jul. 27, 2023, in the Korean Intellectual Property Office, and of a Korean patent application number 10-2023-0148535, filed on Oct. 31, 2023, in the Korean Intellectual Property Office, the disclosure of each of which is incorporated by reference herein in its entirety.

### BACKGROUND

### Field

The disclosure relates to a wearable electronic device for displaying a virtual object and an operating method thereof.

### Description of Related Art

The number of various services and additional functions provided through a wearable electronic device, such as an extended reality (XR) device including augmented reality (AR) glasses, a virtual reality (VR) device, a video see-through (VST) device, and a head-mounted display (HMD) device, is gradually increasing. To increase the utility value of such an electronic device and satisfy the needs of various users, communication service providers or electronic device manufacturers are competitively developing electronic devices to provide various functions and to be differentiated from other companies. Accordingly, various functions provided through a wearable electronic device are becoming increasingly sophisticated.

AR glasses or a VST device may display a virtual image while being worn on a user's body part, thereby providing a realistic experience for the user. AR glasses or a video see-through (VST) device may replace the usability of a smartphone in various fields, such as gaming entertainment, education, and social networking services (SNS). Users may receive content similar to reality through AR glasses or a VST device, and may feel as if the users were staying in a virtual world through interactions.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a wearable electronic device for displaying a virtual object and an operating method thereof.

Additional aspects will be set forth in part in the description which follows and, in part, will be apparent from the description, or may be learned by practice of the presented embodiments.

According to an embodiment, a wearable electronic device may include a camera, a display, communication circuitry, a processor, and memory storing instructions.

According to an embodiment, the wearable electronic device may establish a communication connection with a control device included in a vehicle through the communication circuitry.

According to an embodiment, the wearable electronic device may identify a state of a user in the vehicle through the camera.

According to an embodiment, the wearable electronic device may identify a driving state of the vehicle.

According to an embodiment, the wearable electronic device may determine at least one area for identifying a gesture of the user, based on at least one of the state of the user in the vehicle or the driving state.

According to an embodiment, the wearable electronic device may execute a first function corresponding to a first gesture among at least one function, based on identifying the first gesture of the user in the at least one area.

According to an embodiment, an operating method of a wearable electronic device may include establishing a communication connection with a control device included in a vehicle.

According to an embodiment, the operating method of the wearable electronic device may include identifying a state of a user in the vehicle through a camera of the wearable electronic device.

According to an embodiment, the operating method of the wearable electronic device may include identifying a driving state of the vehicle.

According to an embodiment, the operating method of the wearable electronic device may include determining at least one area for identifying a gesture of the user, based on at least one of the state of the user or the driving state.

According to an embodiment, the operating method of the wearable electronic device may include executing a first function corresponding to a first gesture among at least one function, based on identifying the first gesture of the user in the at least one area.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to various embodiments;

FIG. 2 is a perspective view illustrating the internal configuration of a wearable electronic device according to an embodiment of the disclosure;

FIGS. 3A and 3B illustrate front and back sides of a wearable electronic device according to an embodiment;

FIG. 4 is a schematic block diagram of a system including a wearable electronic device and a control device according to an embodiment;

FIG. 5 is a flowchart illustrating an operation in which a wearable electronic device executes a function corresponding to a gesture of a user according to an embodiment;

FIG. 6A is a flowchart illustrating an operation in which a wearable electronic device displays at least one virtual object when identifying that one hand of a user is in contact with a steering wheel according to an embodiment;

FIG. 6B is a flowchart illustrating an operation in which a wearable electronic device displays at least one virtual object when identifying that both hands of a user are in contact with a steering wheel according to an embodiment;

FIG. 6C is a flowchart illustrating an operation in which a wearable electronic device displays at least one virtual object, based on the driving state of a vehicle, when identifying that one hand of a user is in contact with a steering wheel according to an embodiment;

FIG. 7 is a flowchart illustrating an operation in which a wearable electronic device adjusts the size of at least one area, based on the driving state of a vehicle according to an embodiment;

FIG. 8 is a flowchart illustrating an operation in which a wearable electronic device displays at least one virtual object in an area adjacent to an armrest according to an embodiment;

FIG. 9A is a flowchart illustrating an operation in which a wearable electronic device determines an area for displaying information related to a vehicle when an autonomous mode is configured according to an embodiment;

FIG. 9B is a flowchart illustrating an operation in which a wearable electronic device determines the size of an area for displaying information related to a vehicle when an autonomous mode is configured according to an embodiment;

FIG. 10A illustrates an operation in which a wearable electronic device determines at least one virtual object corresponding to at least one area according to an embodiment;

FIG. 10B illustrates an operation in which a wearable electronic device determines at least one area for identifying a gesture of a user according to an embodiment;

FIG. 11 illustrates an operation in which a wearable electronic device displays at least one object according to an embodiment;

FIGS. 12A and 12B illustrate an operation in which a wearable electronic device adjusts the size of at least one area, based on the driving speed of a vehicle according to an embodiment;

FIGS. 13A and 13B illustrate an operation in which a wearable electronic device adjusts the size of at least one area, based on the rotation angle of a steering wheel according to an embodiment;

FIG. 14 illustrates an operation in which a wearable electronic device determines at least one area according to an embodiment;

FIGS. 15A and 15B illustrate an operation in which a wearable electronic device displays at least one object according to an embodiment;

FIG. 16A illustrates an operation in which a wearable electronic device determines at least one area when a control device is configured in an autonomous driving mode of a vehicle according to an embodiment;

FIG. 16B illustrates an operation in which a wearable electronic device displays information related to a vehicle when a control device is configured in a second-stage autonomous driving mode of a vehicle according to an embodiment; and

FIG. 16C illustrates an operation in which a wearable electronic device displays information related to a vehicle when a control device is configured in a third-stage autonomous driving mode of a vehicle according to an embodiment.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

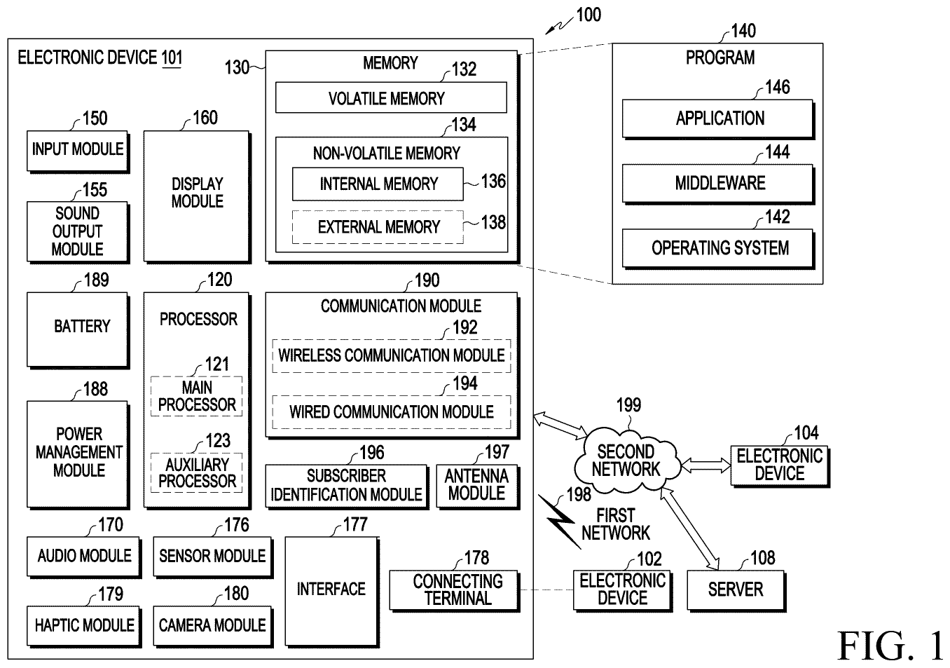

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network, generative adversarial networks (GAN), Transformer or a combination of two or more thereof but is not limited thereto. The artificial intelligence model may, additionally or alternatively, include a software structure other than the hardware structure. According to implementation, the artificial neural network may include at least one of a transformer or generative adversarial network (GAN).

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

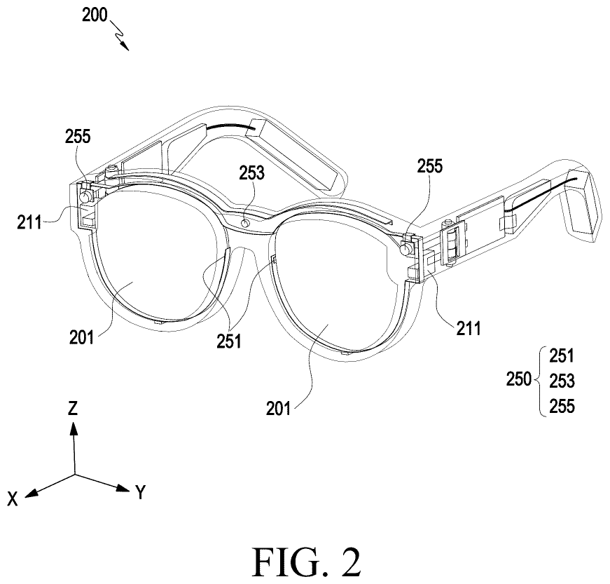

FIG. 2 is a perspective view illustrating an internal configuration of a wearable electronic device according to an embodiment of the disclosure.

Referring to FIG. 2, the wearable electronic device 200 according to an embodiment of the disclosure may include at least one of a light output module 211, a display member 201, and a camera module 250.

According to an embodiment, the light output module 211 may include a light source for outputting an image and a lens that guides an image to the display member 201. According to an embodiment of the disclosure, the light output module 211 may include at least one of a liquid crystal display (LCD), a digital mirror device (DMD), a liquid crystal on silicon (LCoS), an organic light emitting diode (OLED), or a micro light emitting diode (micro LED).

According to an embodiment of the disclosure, the display member 201 may include an optical waveguide (e.g., a wave guide). According to an embodiment of the disclosure, an output image from the light output module 211 entering one end of the optical waveguide may travel in the optical waveguide and be provided to a user. According to an embodiment of the disclosure, the optical waveguide may include at least one of at least one diffractive element (e.g., a diffractive optical element (DOE) and a holographic optical element (HOE)) or a reflective element (e.g., a reflective mirror). For example, the optical waveguide may guide the output image from the light output module 211 to the user's eyes by using the at least one diffractive element or the reflective element.

According to an embodiment of the disclosure, the camera module 250 may capture a still image and/or a video. According to an embodiment, the camera module 250 may be disposed in a lens frame, and disposed near the display member 201.

According to an embodiment of the disclosure, a first camera module 251 may capture and/or recognize a trace of the user's eyes (e.g., pupils or irises) or gaze. According to an embodiment of the disclosure, the first camera module 251 may periodically or aperiodically transmit information related to the trace of the user's eyes or gaze (e.g., trace information) to a processor (e.g., the processor 120 of FIG. 1).

According to an embodiment of the disclosure, a second camera module 253 may capture an external image.

According to an embodiment of the disclosure, a third camera module 255 may be used for hand detection and tracking, and recognition of a user gesture (e.g., a hand movement). The third camera module 255 according to an embodiment of the disclosure may be used for three degrees of freedom (3DoF) or 6DoF head tracking, position (space and environment) recognition, and/or movement recognition. The second camera module 253 may be used for hand detection and tracking and recognition of a user gesture according to an embodiment of the disclosure. According to an embodiment of the disclosure, at least one of the first to third camera modules 251 to 255 may be replaced with a sensor module (e.g., a LiDAR sensor). For example, the sensor module may include at least one of a vertical cavity surface emitting laser (VCSEL), an infrared sensor, and/or a photodiode.

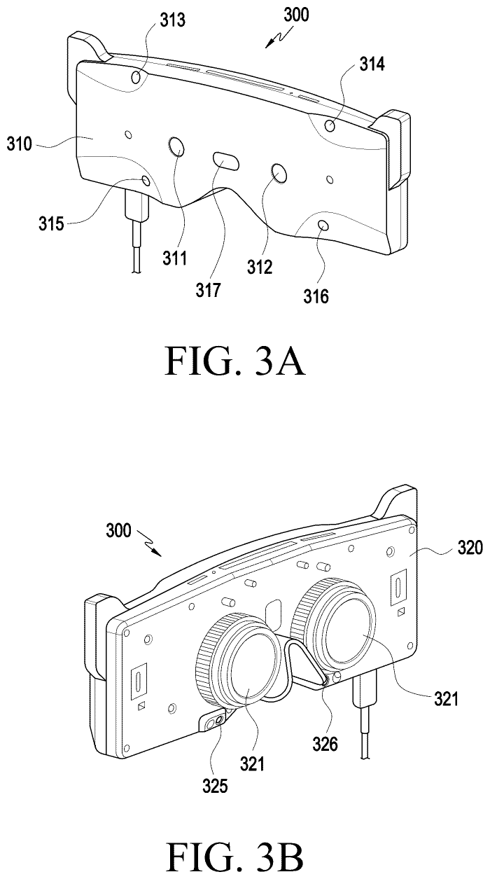

FIGS. 3A and 3B illustrate front and back sides of a wearable electronic device according to an embodiment.

Referring to FIGS. 3A and 3B, in an embodiment, camera modules 311, 312, 313, 314, 315, and 316 and/or a depth sensor 317 configured to obtain information related to a surrounding environment of the wearable electronic device 300 may be disposed on a first side 310 of a housing.

In an embodiment, the camera modules 311 and 312 may obtain an image related to the surrounding environment of the wearable electronic device.

In an embodiment, the camera modules 313, 314, 315, and 316 may obtain an image while the wearable electronic device is worn by a user. The camera modules 313, 314, 315, and 316 may be used for hand detection and tracking and recognition of a user gesture (e.g., a hand movement). The camera modules 313, 314, 315, and 316 may be used for 3DoF or 6DoF head tracking, position (space and environment) recognition, and/or movement recognition. In an embodiment, the camera modules 311 and 312 may be used for hand detection and tracking and a user gesture.

In an embodiment, the depth sensor 317 may be configured to transmit a signal and receive a signal reflected from an object, and may be used to identify a distance to an object, such as time of flight (TOF). Instead of or in addition to the depth sensor 317, the camera modules 313, 314, 315, and 316 may identify the distance to the object.

According to an embodiment, face recognition camera modules 325 and 326 and/or a display 321 (and/or lens) may be disposed on a second side 320 of the housing.

In an embodiment, the face recognition camera modules 325 and 326 adjacent to the display may be used to recognize the user's face, or may recognize and/or track both eyes of the user.

In an embodiment, the display 321 (and/or lens) may be disposed on the second side 320 of the wearable electronic device 300. In an embodiment, the wearable electronic device 300 may not include the camera modules 315 and 316 among the plurality of camera modules 313, 314, 315, and 316. Although not shown in FIGS. 3A and 3B, the wearable electronic device 300 may further include at least one of the components illustrated in FIG. 2.

As described above, the wearable electronic device 300 according to an embodiment may have a form factor to be worn on the user's head. The wearable electronic device 300 may further include a strap and/or a wearing member to be fixed on a user's body part. The wearable electronic device 300 may provide a user experience based on augmented reality, virtual reality, and/or mixed reality while worn on the user's head.

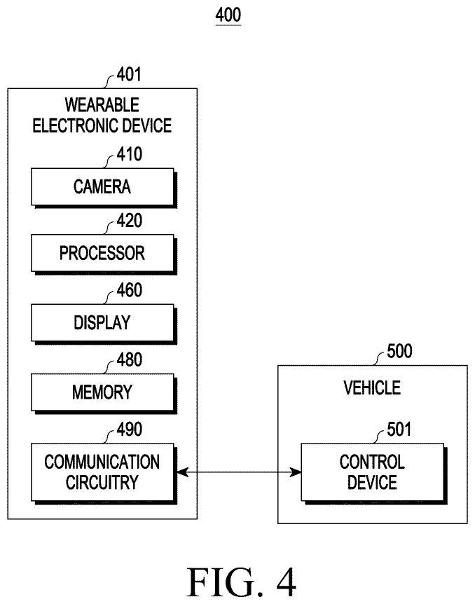

FIG. 4 is a schematic block diagram of a system including a wearable electronic device and a control device according to an embodiment.

Referring to FIG. 4, according to an embodiment, the system 400 may include the wearable electronic device 401 and a vehicle 500.

According to an embodiment, the wearable electronic device 401 may include a camera 410, a processor 420, memory 480, a display 460, and communication circuitry 490. According to an embodiment, the vehicle 500 may include the control device 501 configured to execute a function related to the vehicle 500.

According to an embodiment, the wearable electronic device 401 may be configured the same as or similar to the electronic device 101 of FIG. 1, the wearable electronic device 200 of FIG. 2, and the wearable electronic device 300 of FIGS. 3A and 3B. According to an embodiment, the wearable electronic device 401 may be configured as augmented reality (AR) glasses or a video see-through (VST) device. However, the above examples are for illustration, and embodiments of the disclosure may be configured as various devices.

According to an embodiment, the processor 420 may control an overall operation of the wearable electronic device 401. For example, the processor 420 may be configured the same as or similar to the processor 120 of FIG. 1.

According to an embodiment, the processor 420 may establish a communication connection with the control device 501 through the communication circuitry 490.

According to an embodiment, the processor 420 may identify the position of a user in the vehicle 500 which the user boards by using the camera 410. According to an embodiment, the processor 420 may identify the position of the user in the vehicle 500 by using an ultra-wide band technology between the wearable electronic device 401 and the control device 501 of the vehicle 500. According to an embodiment, the processor 420 may identify the position of the user in the vehicle 500 by using the ultra-wide band technology between the wearable electronic device 401 and an external electronic device. For example, the external electronic device may include a smartphone or a tablet PC. However, the above examples are for illustration, and embodiments of the disclosure may identify the position of the user by various methods.

According to an embodiment, when identifying that the user is positioned in a driver seat, the processor 420 may identify the position of both hands or one hand of the user and the position of a steering wheel of the vehicle 500. According to an embodiment, when identifying that the user is positioned in a seat other than the driver seat, the processor 420 may identify the position of both hands or one hand of the user and the position of an armrest of the vehicle 500.

According to an embodiment, the processor 420 may obtain an image by using the camera 410. According to an embodiment, the processor 420 may obtain depth information from the image by using a sensor (not shown) (e.g., the depth sensor 317 of FIG. 3A). According to an embodiment, the processor 420 may identify the position of both hands or one hand of the user, the position of the steering wheel of the vehicle 500, and/or the position of the armrest of the vehicle 500, based on the depth information. According to an embodiment, the processor 420 may obtain an image by using a camera included in the vehicle 500. According to an embodiment, the processor 420 may obtain the image obtained by the camera included in the vehicle 500 from the control device 501. According to an embodiment, the processor 420 may identify the position of both hands or one hand of the user, the position of the steering wheel of the vehicle 500, and/or the position of the armrest of the vehicle 500, based on depth information about the image obtained by the camera included in the vehicle 500. According to an embodiment, the processor 420 may obtain sensing information obtained by at least one sensor included in the vehicle 500 from the control device 501. According to an embodiment, the processor 420 may identify the position of both hands or one hand of the user, the position of the steering wheel of the vehicle 500, and/or the position of the armrest of the vehicle 500, based on the sensing information. For example, the control device 501 may transmit the sensing information sensed by the sensor included in the vehicle 500 to the wearable electronic device 401. For example, the at least one sensor included in the vehicle 500 may include a motion sensor and/or a touch sensor included in the vehicle 500. For example, the touch sensor may include a touch sensor included in the steering wheel of the vehicle 500. However, the above examples are for illustration, and the at least one sensor may include various sensors, without being not limited thereto.

According to an embodiment, the processor 420 may identify the state of the user boarding the vehicle 500. For example, the state of the user may refer to a state in which both hands or one hand of the user is close to (e.g., in contact with) the steering wheel or armrest of the vehicle 500. According to an embodiment, the state in which both hands or one hand of the user is close to the steering wheel or armrest of the vehicle 500 may refer to a state in which both hands or one hand of the user is separated from the steering wheel or armrest of the vehicle 500 by a specified distance. For example, the specified distance may be configured by the user or be automatically configured by the processor 420. According to an embodiment, the state in which both hands or one hand of the user is close to the steering wheel or armrest of the vehicle 500 may refer to a state in which both hands or one hand of the user is in contact with the steering wheel or armrest of the vehicle 500.

According to an embodiment, the processor 420 may display a configuration screen for configuring at least one area for identifying a gesture of the user, based on identifying that both hands or one hand of the user is proximate to at least one portion of a plurality of portions of the steering wheel of the vehicle 500 or is proximate to the armrest. For example, the at least one area may include an area proximate to the steering wheel of the vehicle 500.

According to an embodiment, the processor 420 may determine at least one area for identifying a gesture of the user, based on identifying a user input to configure at least one area for identifying a gesture of the user. However, this example is for illustration, and the at least one area for identifying the gesture of the user may be automatically configured by the processor 420.

According to an embodiment, the processor 420 may change a size or position of the at least one area for identifying the gesture of the user, based on a driving state of the vehicle 500 and the gaze of the user.

According to an embodiment, the processor 420 may identify the gaze of the user. According to an embodiment, the processor 420 may determine at least one area for identifying at least one gesture of the user, based on the gaze of the user. For example, when a hand of the user is proximate to the steering wheel of the vehicle 500 and the gaze of the user is directed to the steering wheel of the vehicle 500, the processor 420 may determine the at least one area for identifying the gesture of the user to have a first size (or area). For example, the first size may refer to a size configured by the user on the configuration screen. For example, when the hand of the user is proximate to the steering wheel of the vehicle 500 and the gaze of the user is directed to an area other than the steering wheel of the vehicle 500, the processor 420 may determine the at least one area for identifying the gesture of the user to have a size (or area) different from the first size. For example, when the hand of the user is proximate to the steering wheel of the vehicle 500 and the gaze of the user is directed to the area other than the steering wheel of the vehicle 500, the processor 420 may change the position of the at least one area for identifying the gesture of the user. For example, the processor 420 may change the position of the at least one area for identifying the gesture of the user from a position configured by the user through the configuration screen to a position to which the gaze of the user is directed.

For example, when the hand of the user is proximate to the armrest of the vehicle 500 and the gaze of the user is directed to the armrest of the vehicle 500, the processor 420 may determine the at least one area for identifying the gesture of the user to have the first size (or area). For example, when the hand of the user is proximate to the armrest of the vehicle 500 and the gaze of the user is directed to an area other than the armrest of the vehicle 500, the processor 420 may change the position of the at least one area for identifying the gesture of the user. For example, the processor 420 may change the position of the at least one area for identifying the gesture of the user to the position to which the gaze of the user is directed.

According to an embodiment, the processor 420 may display at least one virtual object. For example, the processor 420 may display the at least one virtual object in the at least one area configured as an area for identifying at least one gesture of the user or an area proximate to the at least one area. The processor 420 may display the at least one virtual object in an area different from the at least one area.

According to an embodiment, the at least one virtual object may include at least one virtual object related to the vehicle 500. For example, the at least one virtual object may include at least one of an object related to a function of turning on a turn signal of the vehicle 500, an object related to a function of turning on an emergency light, an object related to a function of establishing a short-distance communication connection between the control device 501 and an external electronic device, or an object related to a function of displaying an image of an external environment of the vehicle 500 captured with the camera included in the vehicle 500. For example, the image of the external environment of the vehicle 500 captured with the camera included in the vehicle 500 may be obtained from the control device 501. However, the above examples are for illustration, and embodiments of the disclosure may include objects related to various functions.

According to an embodiment, the at least one object may include at least one virtual object for controlling the wearable electronic device 401. For example, the at least one virtual object may include at least one of an object related to a function of executing a call application of the wearable electronic device 401, an object related to a function of executing a music application of the wearable electronic device 401, an object related to a function of playing content (e.g., a video) stored in the wearable electronic device 401, or an object related to a function of establishing a short-range communication connection between the wearable electronic device 401 and an external electronic device.

According to an embodiment, the at least one virtual object may be displayed in at least one area specified by the processor 420. According to an embodiment, the processor 420 may display an object related to a function of turning on a left turn signal in an area adjacent to a left portion of the steering wheel of the vehicle 500. For example, the processor 420 may display an object related to a function of turning on a right turn signal in an area adjacent to a right portion of the steering wheel. According to an embodiment, the processor 420 may display the object related to the function of executing the music application of the wearable electronic device 401 in an area adjacent to an upper portion of the steering wheel. According to an embodiment, the processor 420 may display the object related to the function of executing the call application of the wearable electronic device 401 in an area adjacent to a lower portion of the steering wheel. According to an embodiment, the processor 420 may display the object related to the function of displaying the content in an area adjacent to the armrest.

According to an embodiment, the at least one virtual object may be displayed in at least one area specified by a use input. According to an embodiment, when an input for at least one virtual object among a plurality of virtual objects is identified, the processor 420 may configure the at least one virtual object as a virtual object specified for any one of the plurality of portions of the steering wheel. According to an embodiment, the processor 420 may change the virtual object specified for the one of the plurality of portions of the steering wheel, based on an input to change the virtual object specified for the one of the plurality of portions of the steering wheel. According to an embodiment, the processor 420 may display a plurality of virtual objects in an area adjacent to the armrest. According to an embodiment, when an input for at least one virtual object among the plurality of virtual objects is identified, the processor 420 may configure the at least one virtual object as a virtual object specified for the armrest. According to an embodiment, the processor 420 may change the virtual object specified for the one of the plurality of portions of the steering wheel, based on an input to change the virtual object specified for the armrest. According to an embodiment, when identifying that both hands of the user are proximate to (e.g., in contact with) the steering wheel, the processor 420 may display the at least one specified virtual object. According to an embodiment, the processor 420 may display at least one first virtual object in an area adjacent to a first portion of the steering wheel which one hand of the user is proximate to (e.g., in contact with), and may display at least one second virtual object in an area adjacent to a second portion of the steering wheel which the other hand is proximate to (e.g., in contact with). The at least one virtual first object may include a virtual object specified for the first portion of the steering wheel. The at least one second virtual object may include a virtual object specified for the second portion of the steering wheel.

According to an embodiment, when identifying that one hand of the user is proximate to (e.g., in contact with) the steering wheel and the other hand is not proximate to (e.g., in contact with) the steering wheel, the processor 420 may not display the at least one virtual object. According to an embodiment, when identifying that one hand of the user is proximate to (e.g., in contact with) the armrest, the processor 420 may display the at least one virtual object.

According to an embodiment, when identifying that one hand of the user is proximate to (e.g., in contact with) the steering wheel and the other hand is not proximate to (e.g., in contact with) the steering wheel, the processor 420 may identify whether the vehicle 500 is being driven. According to an embodiment, when identifying that the vehicle 500 is being driven, the processor 420 may not display the at least one virtual object. According to an embodiment, when identifying that the vehicle 500 is not being driven, the processor 420 may display the at least one virtual object. According to an embodiment, the processor 420 may display the at least one virtual object in an area adjacent to a portion of the steering wheel which the one hand of the user is proximate to (e.g., in contact with).

According to an embodiment, when identifying that one hand of the user is proximate to (e.g., in contact with) the steering wheel and the other hand is not proximate to (e.g., in contact with) the steering wheel, the processor 420 may identify whether the vehicle 500 is being parked. According to an embodiment, when identifying that the vehicle 500 is being parked, the processor 420 may display the at least one virtual object. According to an embodiment, when identifying that the vehicle 500 is not being parked, the processor 420 may display the at least one virtual object. According to an embodiment, the processor 420 may display the at least one virtual object in an area adjacent to a portion of the steering wheel which the one hand of the user is proximate to (e.g., in contact with).

According to an embodiment, when identifying that one hand of the user is proximate to (e.g., in contact with) the steering wheel and the other hand is not proximate to (e.g., in contact with) the steering wheel, the processor 420 may identify the driving speed of the vehicle. For example, the driving speed may be obtained from the control device 501.

According to an embodiment, when identifying that the driving speed of the vehicle 500 is greater than a first specified speed, the processor 420 may not display the at least one virtual object (e.g., the object related to the function of displaying the content). According to an embodiment, when identifying that the driving speed of the vehicle 500 is less than the first specified speed, the processor 420 may display the at least one virtual object (e.g., the object related to the function of displaying the content). According to an embodiment, the processor 420 may display the at least one virtual object (e.g., the object related to the function of displaying the content) in an area adjacent to a portion of the steering wheel with which the one hand of the user is in contact. For example, the first specified speed may be 30 km/h. However, this example is for illustration, and the first specified speed may not be limited to this example. For example, the first specified speed may be automatically configured by the wearable electronic device 401, or may be configured by the user. For example, the first specified speed may be the driving speed of the vehicle for determining whether to display the at least one virtual object when one hand of the user is proximate to (e.g., in contact with) the steering wheel and the other hand is not proximate to (e.g., in contact with) the steering wheel. According to an embodiment, the processor 420 may adjust the size of the at least one virtual object, based on the driving state of the vehicle 500. For example, the processor 420 may configure a ratio of adjusting the size of the at least one area for identifying the gesture of the user to be the same as a ratio of adjusting the size of the at least one object. Accordingly, when the driving speed of the vehicle 500 or the rotation angle of the steering wheel is large, the processor 420 may reduce the size of the displayed virtual object, thereby providing the user with an environment enabling the user to concentrate on driving the vehicle.

According to an embodiment, the processor 420 may adjust a display position of the at least one virtual object, based on the driving state of the vehicle 500. According to an embodiment, when identifying that the vehicle 500 is being driven, the processor 420 may adjust the display position of the at least one virtual object displayed when the vehicle 500 is being driven from a first display position of the virtual object in a case where the vehicle 500 is not being driven to a second display position. For example, the second display position may be a position which is farther from the position of the steering wheel or the user's hand than the first display position. Depending on implementation, the second display position may be a position which is closer to the position of the steering wheel or the user's hand than the first display position. For example, the at least one virtual object may be fixed and displayed at a specific position (e.g., a windshield of the vehicle 500).

According to an embodiment, the processor 420 may adjust the display position of the at least one virtual object, based on the rotation angle of the steering wheel of the vehicle 500. For example, as the rotation angle of the steering wheel of the vehicle 500 increases, the processor 420 may display the at least one virtual object at a longer distance from the position of the user's hand or the position of the steering wheel of the vehicle 500.

According to an embodiment, the processor 420 may display the at least one virtual object at a position specified for the driving speed of the vehicle 500. For example, as the driving speed of the vehicle 500 increases, the processor 420 may display the at least one virtual object at a longer distance from the position of the user's hand or the position of the steering wheel of the vehicle 500.

According to an embodiment, the processor 420 may adjust the size of the at least one virtual object, based on the driving state of the vehicle 500. According to an embodiment, when identifying that the vehicle 500 is being driven, the processor 420 may display the at least one virtual object by adjusting the size of the at least one virtual object to a second size smaller than a first size of the virtual object in a case where the vehicle 500 is not being driven.

According to an embodiment, the processor 420 may adjust the size of the at least one virtual object, based on the driving speed of the vehicle 500. According to an embodiment, the processor 420 may adjust the size of the at least one virtual object, based on the rotation angle of the steering wheel of the vehicle 500. For example, as the driving speed of the vehicle 500 increases, the processor 420 may display the at least one virtual object by adjusting the size of the virtual object to be smaller. For example, as the rotation angle of the steering wheel of the vehicle 500 increases, the processor 420 may display the at least one virtual object by adjusting the size of the virtual object to be smaller.

According to an embodiment, the processor 420 may not display at least a portion of the at least one virtual object specified for the steering wheel, based on the driving state of the vehicle. For example, the processor 420 may identify that both hands of the user are proximate to (e.g., in contact with) the steering wheel.

For example, when identifying that the vehicle is being driven, the processor 420 may not display the object related to the function of displaying the content (e.g., an image or a video) among the at least one virtual object. For example, when identifying that the vehicle is being driven, the processor 420 may not execute the function of displaying the content even though identifying an input to select the object related to the function of displaying the content among the at least one virtual object while displaying the object related to the function of displaying the content (e.g., the image or the video) on the display 460.

For example, when identifying that the driving speed of the vehicle is greater than the first specified speed, the processor 420 may not display the object related to the function of displaying the content (e.g., the image or the video) among the at least one virtual object. For example, when identifying that the driving speed of the vehicle is greater than the first specified speed, the processor 420 may not execute the function of displaying the content even though identifying the input to select the object related to the function of displaying the content among the at least one virtual object while displaying the object related to the function of displaying the content (e.g., the image or the video) on the display 460.

For example, when identifying that the rotation angle of the steering wheel of the vehicle is greater than a first specified angle, the processor 420 may not display the object related to the function of displaying the content among the at least one virtual object. For example, when identifying that the rotation angle of the steering wheel of the vehicle is greater than the first specified angle, the processor 420 may not execute the function of displaying the content even though identifying the input to select the object related to the function of displaying the content among the at least one virtual object while displaying the object related to the function of displaying the content (e.g., the image or the video) on the display 460.

According to an embodiment, the processor 420 may identify the driving state of the vehicle 500, and may adjust the size of the at least one area for identifying the gesture of the user, based on the driving state. According to an embodiment, the driving state of the vehicle 500 may include a state related to the driving speed of the vehicle 500 or the rotation angle of the steering wheel.

According to an embodiment, as the driving speed of the vehicle 500 increases, the processor 420 may reduce the size of the at least one area for identifying the gesture of the user. According to an embodiment, when identifying that the driving speed of the vehicle 500 is less than the first specified speed, the processor 420 may configure the size of the at least one area for identifying the gesture of the user to the first size. For example, the first size may refer to the size configured by the user on the configuration screen. According to an embodiment, when identifying that the driving speed of the vehicle 500 is greater than the first specified speed, the processor 420 may configure the size of the at least one area for identifying the gesture of the user to a second size smaller than the first size. For example, the first specified speed may refer to 30 km/h. However, this example is for illustration, and the first specified speed may not be limited to this example. For example, the first specified speed may be automatically configured by the wearable electronic device 401, or may be configured by the user. For example, the first specified speed may refer to the driving speed of the vehicle 500 for determining the size of the at least one area.

According to an embodiment, as the rotation angle of the steering wheel of the vehicle 500 increases, the processor 420 may reduce the size (or area) of the at least one area for identifying the gesture of the user. According to an embodiment, when identifying that the rotation angle of the steering wheel is less than the first specified angle, the processor 420 may configure the size of the at least one area for identifying the gesture of the user to the first size. According to an embodiment, when identifying that the rotation angle of the steering wheel is greater than the first specified angle, the processor 420 may configure the size of the at least one area for identifying the gesture of the user to the second size smaller than the first size. For example, the first specified angle may refer to 10 degrees. However, this example is for illustration, and the first specified angle may not be limited to this example. For example, the first specified angle may be automatically configured by the processor 420, or may be configured by the user. Accordingly, when the driving speed of the vehicle 500 or the rotation angle of the steering wheel is large, the processor 420 may reduce the size of the at least one area for identifying the gesture of the user, thereby providing the user with an environment enabling the user to concentrate on driving the vehicle.

According to an embodiment, the processor 420 may change the position of the at least one area for identifying the gesture of the user, based on the gaze of the user. For example, the processor 420 may change the position of the at least one area for identifying the gesture of the user to a position to which the gaze of the user is directed.

According to an embodiment, the processor 420 may identify a first gesture of the user with respect to the at least one virtual object in the at least one area for identifying the gesture of the user. According to an embodiment, the processor 420 may identify that there is an input to the at least one virtual object displayed on the display 460, based on identifying the first gesture in the at least one area for identifying the gesture of the user. For example, the first gesture may be a gesture specified for the at least one virtual object. According to an embodiment, when identifying the first gesture of the user with respect to the at least one virtual object in the at least one area for identifying the gesture of the user in a state in which both hands of the user are in contact with the steering wheel, the processor 420 may identify that there is an input to the at least one virtual object. According to an embodiment, when identifying the first gesture of the user with respect to the at least one virtual object in a state in which any one hand of the user is in contact with the steering wheel, the processor 420 may identify that there is an input to the at least one virtual object.

According to an embodiment, when identifying the first gesture of the user with respect to the at least one virtual object in an area other than the at least one area for identifying the gesture of the user, the processor 420 may identify that there is no input to the at least one virtual object. Depending on implementation, according to an embodiment, when identifying the first gesture of the user with respect to the at least one virtual object in an area where the at least one virtual object is displayed, the processor 420 may identify that there is an input to the at least one virtual object.

According to an embodiment, the processor 420 may identify the first gesture, based on a movement speed or movement distance of a specific finger among the user's fingers. According to an embodiment, when the at least one area is the area adjacent to the right portion of the steering wheel, the processor 420 may identify the first gesture, based on a movement distance or movement speed of a right finger. According to an embodiment, when the at least one area is the area adjacent to the left portion of the steering wheel, the processor 420 may identify the first gesture, based on a movement distance or movement speed of a left finger. According to an embodiment, when the at least one area is the area adjacent to the lower portion of the steering wheel, the processor 420 may identify the first gesture, based on the movement distance or movement speed of the right or left finger. According to an embodiment, when the at least one area is the area adjacent to the upper portion of the steering wheel, the processor 420 may identify the first gesture, based on the movement distance or movement speed.

For example, when the movement speed of the specific finger is greater than a first speed and less than a second speed, the processor 420 may determine that the first gesture of selecting a first object among the at least one virtual object displayed on the display 460 is identified. For example, when the movement speed of the specific finger is greater than the second speed and less than a third speed, the processor 420 may determine that the first gesture of selecting a second object among the at least one virtual object displayed on the display 460 is identified. For example, the third speed may include a speed greater than the second speed.

For example, when the movement distance of the specific finger is greater than a first distance and less than a second distance, the processor 420 may determine that the first gesture of selecting the first object among the at least one virtual object displayed on the display 460 is identified. For example, when the movement distance of the specific finger is greater than the second distance and less than a third distance, the processor 420 may determine that the first gesture of selecting the second object among the at least one virtual object displayed on the display 460 is identified. For example, the third distance may include a distance greater than the second distance.

According to an embodiment, the processor 420 may identify the first gesture, based on the size (or area) of the at least one area for identifying the gesture of the user and the movement speed or movement distance of the specific finger among the user's fingers. According to an embodiment, as the size (or area) of the at least one area for identifying the gesture of the user is smaller, the movement speed or the movement distance for the processor 420 determining that the gesture of the user is identified may be smaller. Accordingly, according to an embodiment, when the at least one area for identifying the gesture of the user is small, a movement of the finger of the user may be relatively small. The processor 420 may adjust the recognition rate of the gesture of the user, based on the size of the at least one area.

According to an embodiment, the processor 420 may identify the first gesture, based on at least one of the movement direction or shape of a specific finger among the user's fingers. According to an embodiment, when the at least one area is the area adjacent to the right portion of the steering wheel, the processor 420 may identify the first gesture, based on at least one of the movement direction or shape of a right finger. According to an embodiment, when the at least one area is the area adjacent to the left portion of the steering wheel, the processor 420 may identify the first gesture, based on at least one of the movement direction or shape of a left finger. According to an embodiment, when the at least one area is the area adjacent to the lower portion of the steering wheel, the processor 420 may identify the first gesture, based on at least one of the movement direction or shape of the right or left finger. According to an embodiment, when the at least one area is the area adjacent to the upper portion of the steering wheel, the processor 420 may identify the first gesture, based on at least one of the movement direction or shape of the right or left finger. For example, the first gesture may include a gesture of unfolding the specific finger (e.g., thumb) and folding the other fingers. For example, the first gesture may include moving the specific finger from left to right a specific number of times. For example, the first gesture may include a gesture of bending the specific finger. For example, the first gesture may include rotating the specific finger a specific number of times. For example, the first gesture may include rotating the specific finger clockwise or counterclockwise a specific number of times. For example, the first gesture may include a gesture of the user's hand coming in contact with (e.g., approaching or grabbing) the steering wheel of the vehicle 500. However, the above examples are for illustration, and the first gesture and the direction of the user's hand (e.g., right hand and left hand) may not be limited to the above examples.

According to an embodiment, the processor 420 may display a plurality of virtual objects in an area adjacent to any one of the plurality of portions. According to an embodiment, when identifying the first gesture of the user, the processor 420 may display a virtual pointer. According to an embodiment, the processor 420 may display the virtual pointer in the area adjacent to the one of the plurality of portions. For example, the first gesture may include a gesture of unfolding a specific finger of any one hand of the user. According to an embodiment, when identifying a second gesture of the user, the processor 420 may move the virtual pointer. For example, the second gesture may include a gesture of moving the specific finger of the one hand of the user from bottom to top. When identifying the second gesture, the processor 420 may move the virtual pointer from bottom to top. According to an embodiment, when identifying a third gesture of the user, the processor 420 may identify that there is an input to a virtual object included in the plurality of virtual objects displayed in the position of the virtual pointer. For example, the third gesture may include a gesture of bending the specific finger of the one hand of the user. However, the above examples are for illustration, and the first gesture, the second gesture, and the third gesture may not be limited to the above examples.

According to an embodiment, the processor 420 may transmit a signal corresponding to the first gesture to the control device 501, based on identifying the first gesture. According to an embodiment, the signal corresponding to the first gesture may include a control signal related to the vehicle 500 to execute a first function corresponding to the first gesture. According to an embodiment, the processor 420 may transmit the control signal to the control device 501 to execute the function of turning on the turn signal, the function of executing the call application, the function of turning on the emergency light, the function of executing the music application, the function of establishing the short-distance communication connection, the function of displaying the captured image of the external environment of the vehicle 500, or the function of displaying the content. For example, the control device 501 may execute a call application of an external electronic device connected to the control device 501, based on the control signal. For example, the control device 501 may execute a music application of an external electronic device connected to the control device 501, based on the control signal. For example, the control device 501 may turn on the turn signal or turn on the emergency light, based on the control signal. For example, the control device 501 may transmit an image obtained with the camera included in the vehicle 500 to the wearable electronic device 401, based on the control signal. The processor 420 may display the obtained image. However, the above examples are for illustration, and the function corresponding to the first gesture may not be limited to the above examples.

According to an embodiment, when identifying the first gesture in the at least one area, the processor 420 may transmit the control signal related to the vehicle 500 to the control device 501 to execute the first function corresponding to the first gesture. According to an embodiment, when identifying the first gesture in an area other than the at least one area, the processor 420 may not transmit the control signal to the control device 501.

According to an embodiment, the processor 420 may execute the first function corresponding to the first gesture, based on identifying the first gesture in the at least one area. According to an embodiment, the processor 420 may establish a short-range communication connection with an external electronic device. According to an embodiment, the processor 420 may establish a short-range communication connection with an external electronic device connected to the control device 501. According to an embodiment, the processor 420 may execute a call application of the external electronic device which establishes the communication connection with the wearable electronic device 401. According to an embodiment, the processor 420 may execute a music application of the external electronic device which establishes the communication connection with the wearable electronic device 401. According to an embodiment, the processor 420 may display content stored in the memory 480. According to an embodiment, the processor 420 may obtain content from the external electronic device which establishes the communication connection with the wearable electronic device 401, and may display the content.

According to an embodiment, after executing the first function corresponding to the first gesture, the processor 420 may execute a second function following the first function. According to an embodiment, the processor 420 may execute the first function when identifying the first gesture, and may execute the second function after the first function is executed even though no additional gesture is identified.

According to an embodiment, after executing the first function corresponding to the first gesture, the processor 420 may identify an additional gesture to execute the second function following the first function. According to an embodiment, when identifying the additional gesture, the processor 420 may execute the second function. For example, the additional gesture may include a gesture of unfolding a specific finger (e.g., thumb) and folding the other fingers. For example, the additional gesture may include moving a specific finger from left to right a specific number of times. For example, the additional gesture may include a gesture of bending a specific finger. For example, the additional gesture may include rotating a specific finger a specific number of times. For example, the additional gesture may include rotating a specific finger clockwise or counterclockwise a specific number of times. For example, the additional gesture may include a gesture of the user's hand coming in contact with (e.g., approaching or grabbing) the steering wheel of the vehicle 500. However, the above examples are for illustration, and the additional gesture and the direction of the user's hand (e.g., right hand and left hand) may not be limited to the above examples.

For example, the first function may include the function of turning on the turn signal or the function of turning on the emergency light. For example, the second function may include the function of displaying the image of the external environment of the vehicle 500 captured with the camera included in the vehicle 500. According to an embodiment, after turning on the turn signal, the processor 420 may obtain an image of an external environment of the vehicle 500 captured with the camera included in the vehicle 500 from the control device 501. According to an embodiment, the processor 420 may display the captured image of the external environment of the vehicle 500.

According to an embodiment, the processor 420 may identify a gesture of the user to display a virtual object which is not displayed on the display 460 on the display 460. According to an embodiment, when identifying the gesture of the user to display the virtual object which is not displayed on the display 460 on the display 460, the processor 420 may display the virtual object on the display 460.

Operations of the wearable electronic device 401 described below with reference to the drawings may be performed by the processor 420. However, for convenience of explanation, the operations performed by the processor 420 will be described as being performed by the wearable electronic device 401.

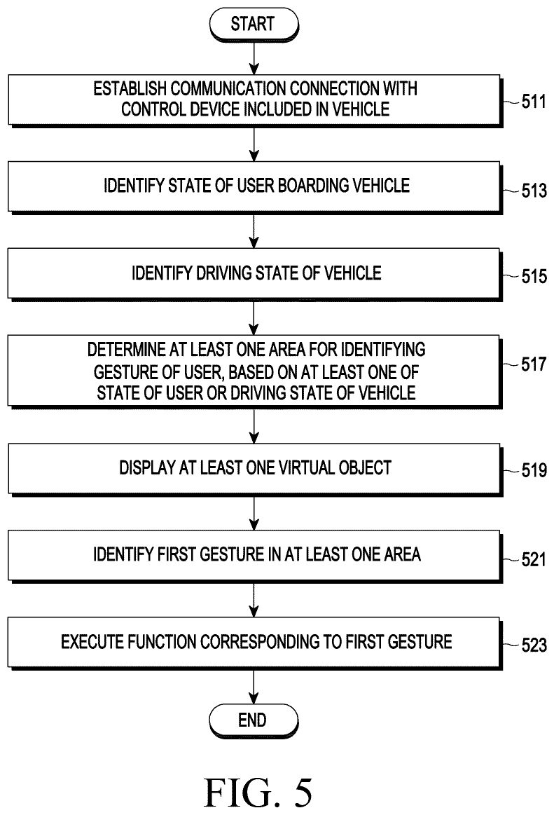

FIG. 5 is a flowchart illustrating an operation in which a wearable electronic device executes a function corresponding to a gesture of a user according to an embodiment.

Referring to FIG. 5, according to an embodiment, in operation 511, a wearable electronic device 401 (e.g., the wearable electronic device 401 of FIG. 4) may establish a communication connection with a control device (e.g., the control device 501 in FIG. 4) included in a vehicle 500 (e.g., the vehicle 500 of FIG. 4).

According to an embodiment, the wearable electronic device 401 may identify the vehicle 500, based on strength of a communication signal with the control device 501 included in the vehicle 500. According to an embodiment, the wearable electronic device 401 may identify the vehicle 500 through a camera 410 (e.g., the camera 410 of FIG. 4). According to an embodiment, the wearable electronic device 401 may also identify the vehicle 500 by using an external electronic device (e.g., a smartphone, a tablet PC, or an external wearable electronic device different from the wearable electronic device 401) which establishes a communication connection with the wearable electronic device 401.

According to an embodiment, when the vehicle 500 is identified, the wearable electronic device 401 may identify whether a key (e.g., a digital key) of the vehicle 500 is stored in the wearable electronic device 401. For example, the digital key may include information about identification. According to an embodiment, the wearable electronic device 401 may identify whether the key (e.g., the digital key) of the vehicle 500 is stored in the external electronic device which establishes the communication connection with the wearable electronic device 401. According to an embodiment, the wearable electronic device 401 may obtain the key (e.g., the digital key) of the vehicle 500 from the external electronic device.

According to an embodiment, the wearable electronic device 401 may transmit the key (e.g., the digital key) of the vehicle 500 to the control device 501. According to an embodiment, the control device 501 may identify whether a key of the vehicle 500 stored in the control device 501 matches the key of the vehicle 500 received from the wearable electronic device 401. According to an embodiment, the control device 501 may unlock the vehicle 500, based on the key of the vehicle 500 stored in the control device 501 matching the key of the vehicle 500 received from the wearable electronic device 401.

Depending on implementation, according to an embodiment, the wearable electronic device 401 and the control device 501 may perform authentication of a user. For example, the control device 501 may store a specified ID and a specified password related to the vehicle 500. According to an embodiment, the wearable electronic device 401 may receive an ID and a password from the user. According to an embodiment, the control device 501 may compare the ID and the password obtained from the wearable electronic device 401 with the specified ID and the specified password, respectively. According to an embodiment, when the ID and the password obtained from the wearable electronic device 401 match the specified ID and the specified password, the control device 501 may unlock the vehicle 500. Depending on implementation, according to an embodiment, the vehicle 500 may be unlocked by iris recognition or fingerprint recognition of the user.

According to an embodiment, in operation 513, the wearable electronic device 401 may identify the state of the user boarding the vehicle. According to an embodiment, the wearable electronic device 401 may identify the state of the user, based on the position of the user in the vehicle 500 which the user boards.

According to an embodiment, the state of the user may include a state regarding the position of both hands of the user. For example, the state of the user may include a state in which both hands or one hand of the user is proximate to (e.g., in contact with) a steering wheel or armrest of the vehicle 500. According to an embodiment, the wearable electronic device 401 may identify the position of the user in the vehicle 500 which the user board or the state of the user by using the camera 410 (e.g., the camera 410 of FIG. 4). According to an embodiment, the wearable electronic device 401 may obtain information about the state of the user from the control device 501 (e.g., the control device 501 of FIG. 4). For example, the control device 501 may obtain the information about the state of the user through at least one sensor (e.g., a touch sensor or a motion sensor) or a camera included in the vehicle 500.

According to an embodiment, when identifying that the user is positioned in a driver seat, the wearable electronic device 401 may identify whether both hands or one hand of the user is proximate to the steering wheel of the vehicle. According to an embodiment, when identifying that the user is positioned in a seat other than the driver seat, the wearable electronic device 401 may identify whether both hands or one hand of the user is proximate to the armrest. According to an embodiment, the wearable electronic device 401 may display a configuration screen for configuring at least one area for identifying a gesture of the user, based on identifying that both hands or one hand of the user is proximate to the steering wheel or is proximate to the armrest. For example, the at least one area may include an area proximate to the steering wheel of the vehicle 500. According to an embodiment, the at least one area for identifying the gesture of the user may be automatically configured by the wearable electronic device 401.

According to an embodiment, the state of the user may include the gaze of the user. According to an embodiment, the wearable electronic device 401 may identify the gaze of the user through the camera 410.

According to an embodiment, in operation 515, the wearable electronic device 401 may identify a driving state of the vehicle 500. For example, the driving state of the vehicle 500 may include a state in which the vehicle 500 is being driven, a state in which the vehicle 500 stops, or state in which the vehicle 500 is parked. For example, the driving state of the vehicle 500 may include a state regarding the driving speed of the vehicle 500 or the rotation angle of the steering wheel of the vehicle 500.

According to an embodiment, in operation 517, the wearable electronic device 401 may determine the at least one area for identifying the gesture of the user, based on at least one of the state of the user or the driving state of the vehicle 500. According to an embodiment, although operation 517 is described as being performed after operation 515, operation 517 may be performed first and then operation 515 may be performed.

According to an embodiment, the wearable electronic device 401 may configure at least one area proximate to at least one portion among a plurality of portions of the steering wheel of the vehicle as the at least one area for identifying at least one gesture of the user, based on identifying that both hands or one hand of the user is proximate to the at least one portion. For example, the plurality of portions may include an upper portion of the steering wheel, a lower portion of the steering wheel, a right portion of the steering wheel, and a left portion of the steering wheel.

According to an embodiment, the wearable electronic device 401 may configure an area proximate to the armrest of the vehicle as the at least one area for identifying the at least one gesture of the user, based on identifying that one hand of the user is proximate to the armrest. According to an embodiment, when a hand of the user is proximate to the steering wheel of the vehicle 500 and the gaze of the user is directed to an area (e.g., a side-view mirror or a room mirror) other than the steering wheel of the vehicle 500, the wearable electronic device 401 may adjust the size of the at least one area for identifying the gesture of the user to a second size greater than a first size. For example, the first size and the second size may be configured by the user or by the wearable electronic device 401. For example, the first size may refer to a reference size before adjustment. Depending on implementation, when the hand of the user is proximate to the steering wheel of the vehicle 500 and the gaze of the user is directed to the area (e.g., the side-view mirror or the room mirror) other than the steering wheel of the vehicle 500, the wearable electronic device 401 may adjust the size of the at least one area for identifying the gesture of the user to a size less than the first size.

According to an embodiment, when a hand of the user is proximate to the armrest of the vehicle 500 and the gaze of the user is directed to an area other than the armrest of the vehicle 500, the wearable electronic device 401 may adjust the size of the at least one area for identifying the gesture of the user to a second size greater than a first size. For example, the first size and the second size may be configured by the user or by the wearable electronic device 401. For example, the first size may refer to a reference size before adjustment. Depending on implementation, when the hand of the user is proximate to the armrest of the vehicle 500 and the gaze of the user is directed to the area other than the armrest of the vehicle 500, the wearable electronic device 401 may adjust the size of the at least one area for identifying the gesture of the user to a size less than the first size.

According to an embodiment, in operation 519, the wearable electronic device 401 may display at least one virtual object. For example, the wearable electronic device 401 may display the at least one virtual object in the at least one area configured as the area for identifying the at least one gesture or in an area adjacent to the at least one area. The wearable electronic device 401 may display the at least one virtual object in an area different from the at least one area. However, the above examples are for illustration, and positions where the at least one virtual object is displayed may not be limited to the above examples.

According to an embodiment, the at least one virtual object may include at least one virtual object related to the vehicle 500. For example, the at least one virtual object may include at least one of an object related to a function of turning on a turn signal of the vehicle 500, an object related to a function of turning on an emergency light, an object related to a function of establishing a short-distance communication connection between the control device 501 and an external electronic device, or an object related to a function of displaying an image of an external environment of the vehicle 500 captured with the camera included in the vehicle 500. For example, the image of the external environment of the vehicle 500 captured with the camera included in the vehicle 500 may be obtained from the control device 501. However, the above examples are for illustration, and embodiments of the disclosure may include objects related to various functions.

According to an embodiment, the at least one virtual object may include at least one virtual object for controlling the wearable electronic device 401. For example, the at least one virtual object may include at least one of an object related to a function of executing a call application of the wearable electronic device 401, an object related to a function of executing a music application of the wearable electronic device 401, an object related to a function of playing content (e.g., a video) stored in the wearable electronic device 401, or an object related to a function of establishing a short-range communication connection between the wearable electronic device 401 and an external electronic device.

According to an embodiment, the at least one virtual object may be displayed in at least one area specified by the wearable electronic device 401. According to an embodiment, the at least one virtual object may be displayed in at least one area specified by a user input. For example, the wearable electronic device 401 may display an object related to a function of turning on a left turn signal in an area adjacent to the left portion of the steering wheel of the vehicle 500. For example, the wearable electronic device 401 may display an object related to a function of turning on a right turn signal in an area adjacent to a right portion of the steering wheel. For example, the wearable electronic device 401 may display the object related to the function of executing the music application in the upper portion of the steering wheel. For example, the wearable electronic device 401 may display the object related to the function of executing the call application in the lower portion of the steering wheel. For example, the wearable electronic device 401 may display the object related to the function of displaying the content (e.g., a video or an image) in an area adjacent to the armrest.

According to an embodiment, in operation 521, the wearable electronic device 401 may identify a first gesture in the at least one area for identifying the gesture of the user. According to an embodiment, the wearable electronic device 401 may identify the first gesture, based on at least one of the movement direction or shape of a specific finger of the user. For example, the first gesture may refer to a gesture of unfolding the specific finger (e.g., thumb) and folding the other fingers. For example, the first gesture may refer to moving the specific finger from left to right a specific number of times. For example, the first gesture may refer to a gesture of bending the specific finger. For example, the first gesture may refer to rotating the specific finger a specific number of times. For example, the first gesture may refer to rotating the specific finger clockwise or counterclockwise a specific number of times. However, the above examples are for illustration, and the first gesture may not be limited to the above examples.

According to an embodiment, in operation 523, the wearable electronic device 401 may execute a function corresponding to the first gesture, based on identifying the first gesture in the at least one area for identifying the gesture of the user. According to an embodiment, the wearable electronic device 401 may not execute the function corresponding to the first gesture, based on identifying the first gesture in an area other than the at least one area for identifying the gesture of the user.

For example, when identifying that the function corresponding to the first gesture is a first function related to the vehicle 500, the wearable electronic device 401 may transmit a control signal to enable the control device 501 to execute the first function to the control device 501. According to an embodiment, when identifying the first gesture in an area different from the at least one area, the wearable electronic device 401 may not transmit the control signal to execute the function corresponding to the first gesture to the control device 501.

For example, the control device 501 may execute a call application of an external electronic device connected to the control device 501, based on the control signal. The control device 501 may execute a music application of an external electronic device connected to the control device 501, based on the control signal. For example, the control device 501 may turn on the turn signal or turn on the emergency light, based on the control signal. For example, the control device 501 may establish a short-range communication connection with an external electronic device connected to the control device 501. For example, the external electronic device may be a smartphone, a tablet PC, or an external wearable electronic device different from the wearable electronic device 401.

For example, when identifying that the function corresponding to the first gesture is a second function related to the wearable electronic device 401, the wearable electronic device 401 may execute the second function. According to an embodiment, when the first gesture is identified in an area different from the at least one area, the wearable electronic device 401 may not execute the second function.

For example, when identifying that the function corresponding to the first gesture is the second function related to the wearable electronic device 401, the wearable electronic device 401 may establish a short-distance communication connection with the external electronic device. For example, when identifying that the function corresponding to the first gesture is the second function related to the wearable electronic device 401, the wearable electronic device 401 may execute a call application of the external electronic device (e.g., a smartphone) which establishes the communication connection with the wearable electronic device 401. For example, when identifying that the function corresponding to the first gesture is the second function related to the wearable electronic device 401, the wearable electronic device 401 may execute a call application of the wearable electronic device 401. According to an embodiment, the wearable electronic device 401 may execute a music application on the external electronic device (e.g., the smartphone) which establishes the communication connection with the wearable electronic device 401. For example, when identifying that the function corresponding to the first gesture is the second function related to the wearable electronic device 401, the wearable electronic device 401 may execute a music application of the wearable electronic device 401. For example, when identifying that the function corresponding to the first gesture is the second function related to the wearable electronic device 401, the wearable electronic device 401 may display content stored in memory 480 (e.g., the memory 480 of FIG. 4). For example, when identifying that the function corresponding to the first gesture is the second function related to the wearable electronic device 401, the wearable electronic device 401 may obtain content from the external electronic device (e.g., the smartphone) which establishes the communication connection with the wearable electronic device 401, and may display the content.

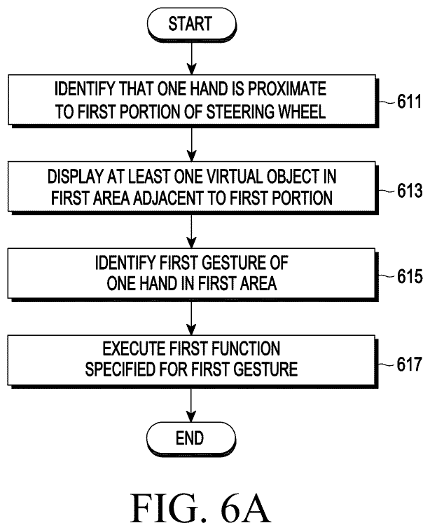

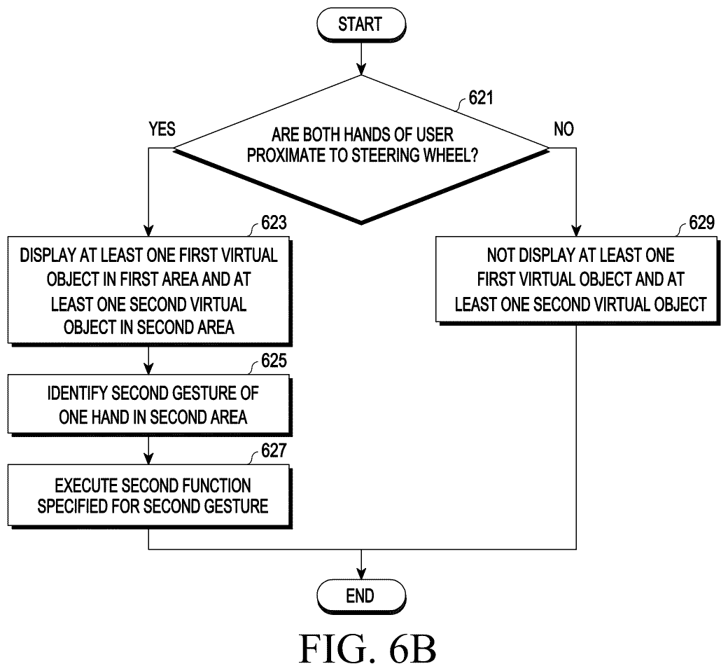

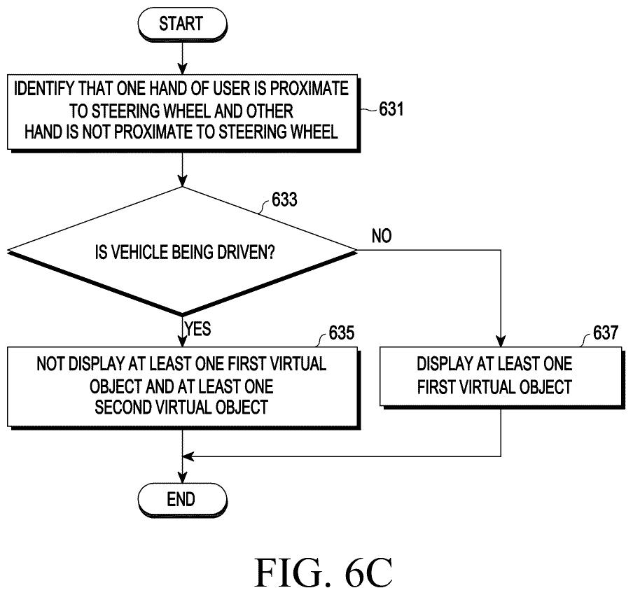

FIG. 6A is a flowchart illustrating an operation in which a wearable electronic device displays at least one virtual object when identifying that one hand of a user is in contact with a steering wheel according to an embodiment.

Referring to FIG. 6A, according to an embodiment, in operation 611, a wearable electronic device 401 (e.g., the wearable electronic device 401 of FIG. 4) may identify that one hand of a user is proximate to (e.g., in contact with) a first portion of a steering wheel of a vehicle 500 by using a camera 410 (e.g., the camera 410 of FIG. 4). For example, the first portion of the steering wheel may include an upper portion of the steering wheel, a lower portion of the steering wheel, a right portion of the steering wheel, or a left portion of the steering wheel.

According to an embodiment, in operation 613, the wearable electronic device 401 may display at least one virtual object in a first area adjacent to the first portion. According to an embodiment, the at least one virtual object may include a virtual object specified for the first portion.

According to an embodiment, in operation 615, the wearable electronic device 401 may identify a first gesture of the one hand in the first area. For example, the first area may refer to an area included in at least one area for identifying a gesture of the user. For example, the first gesture may be a gesture specified for the at least one virtual object.

According to an embodiment, the wearable electronic device 401 may identify the first gesture, based on at least one of the movement direction or shape of a specific finger among the user's fingers. For example, the first gesture may refer to a gesture of unfolding the specific finger (e.g., thumb) and folding the other fingers. For example, the first gesture may refer to moving the specific finger from left to right a specific number of times. For example, the first gesture may refer to a gesture of bending the specific finger. For example, the first gesture may refer to rotating the specific finger a specific number of times. For example, the first gesture may refer to rotating the specific finger clockwise or counterclockwise a specific number of times. However, the above examples are for illustration, and the first gesture may not be limited to the above examples.

According to an embodiment, in operation 617, the wearable electronic device 401 may execute a first function specified for the first gesture, based on identifying the first gesture of the one hand in the first area.

FIG. 6B is a flowchart illustrating an operation in which a wearable electronic device displays at least one virtual object when identifying that both hands of a user are in contact with a steering wheel according to an embodiment.

Referring to FIG. 6B, according to an embodiment, in operation 621, a wearable electronic device 401 (e.g., the wearable electronic device 401 of FIG. 4) may identify whether both hands of a user are proximate to a steering wheel of a vehicle 500 (e.g., the vehicle 500 of FIG. 4).

According to an embodiment, when identifying that both hands of the user are proximate to the steering wheel (Yes in operation 621), the wearable electronic device 401 may display at least one first virtual object in a first area and at least one second virtual object in a second area in operation 623. According to an embodiment, the wearable electronic device 401 may identify that the user's left hand is proximate to a first portion of the steering wheel and that the user's right hand is proximate to a second portion of the steering wheel. According to an embodiment, the first portion and the second portion may be different from each other. For example, the first portion of the steering wheel may include a left portion of the steering wheel. For example, the second portion of the steering wheel may include a right portion of the steering wheel.

According to an embodiment, the at least one first virtual object may include, among at least one virtual object, a virtual object specified to be displayed in the first area when one hand of the user is proximate to the first portion of the steering wheel and the other hand of the user is proximate to the second portion of the steering wheel. According to an embodiment, the at least one second virtual object may include, among the at least one virtual object, a virtual object specified to be displayed in the second area when one hand of the user is proximate to the first portion of the steering wheel and the other hand of the user is proximate to the second portion of the steering wheel.

According to an embodiment, the at least one first virtual object may include at least one virtual object related to at least one of a function of turning on a left turn signal, a function of executing a call application, a function of turning on an emergency light, or a function of turning on a music application. According to an embodiment, the at least one second virtual object may include at least one virtual object related to at least one of a function of turning on a right turn signal, the function of executing the call application, the function of turning on the emergency light, or the function of turning on the music application. However, the above examples are for illustration, and examples of the virtual object may not be limited to the above examples.

According to an embodiment, in operation 625, the wearable electronic device 401 may identify a second gesture of one hand in the second area.

According to an embodiment, in operation 627, the wearable electronic device 401 may execute a second function corresponding to the second gesture by using a control device 501 (e.g., the control device 501 of FIG. 4).

According to an embodiment, when identifying that both hands of the user are not proximate to the steering wheel (No in operation 621), the wearable electronic device 401 may not display the at least one first virtual object and the at least one second virtual object in operation 629. According to an embodiment, when identifying that one hand of the user is proximate to the first portion of the steering wheel and the other hand of the user is not in contact with the steering wheel, the wearable electronic device 401 may not display both the at least one first virtual object and the at least one second virtual object. According to an embodiment, when identifying that one hand of the user is not in contact with the first portion of the steering wheel and the other hand of the user is in contact with the steering wheel, the wearable electronic device 401 may not display the at least one first virtual object and the at least one second virtual object.

Depending on implementation, according to an embodiment, the at least one first virtual object may include, among at least one virtual object, a virtual object specified to be displayed in the first area when one hand of the user is proximate to the first portion of the steering wheel and the other hand of the user is not proximate to the second portion of the steering wheel. According to an embodiment, when one hand of the user is proximate to the first portion of the steering wheel and the other hand of the user is not proximate to the second portion of the steering wheel, the wearable electronic device 401 may display the at least one first virtual object in the first area.

According to an embodiment, the at least one second virtual object may include, among at least one virtual object, at least one virtual object specified to be displayed in the second area when one hand of the user is not proximate to the first portion of the steering wheel and the other hand of the user is proximate to the second portion of the steering wheel. According to an embodiment, when one hand of the user is not proximate to the first portion of the steering wheel and the other hand of the user is proximate to the second portion of the steering wheel, the wearable electronic device 401 may display the least one second virtual object in the second area.

Depending on implementation, according to an embodiment, the at least one first virtual object may include a virtual object specified to be displayed in the first area when both hands of the user are not proximate to the steering wheel. According to an embodiment, when both hands of the user are not proximate to the steering wheel, the wearable electronic device 401 may display the at least one first virtual object in the first area. According to an embodiment, the at least one second virtual object may include a virtual object specified to be displayed in the second area when both hands of the user are not proximate to the steering wheel. According to an embodiment, when both hands of the user are not proximate to the steering wheel, the wearable electronic device 401 may display the at least one second virtual object in the second area.

FIG. 6C is a flowchart illustrating an operation in which a wearable electronic device displays at least one virtual object, based on the driving state of a vehicle, when identifying that one hand of a user is in contact with a steering wheel according to an embodiment.

Referring to FIG. 6C, according to an embodiment, in operation 631, a wearable electronic device 401 (e.g., the wearable electronic device 401 of FIG. 4) may identify that one hand is proximate to a steering wheel of a vehicle 500 (e.g., the vehicle 500 of FIG. 4) and the other hand is not proximate to the steering wheel.

According to an embodiment, in operation 633, the wearable electronic device 401 may identify whether the vehicle 500 is being driven. According to an embodiment, the wearable electronic device 401 may identify whether the vehicle 500 is being driven by using a sensor included in the wearable electronic device 401. According to an embodiment, the wearable electronic device 401 may identify whether the vehicle 500 is being driven, based on a movement speed obtained using the sensor. According to an embodiment, the wearable electronic device 401 may identify whether the vehicle 500 is being driven, based on sensing information obtained from a control device 501 (e.g., the control device 501 of FIG. 4) included in the vehicle 500. For example, the sensing information may include information about the driving speed of the vehicle 500.

According to an embodiment, when identifying that the vehicle 500 is being driven (Yes in operation 633), the wearable electronic device 401 may not display at least one first virtual object and at least one second virtual object among at least one virtual object in operation 635. According to an embodiment, when identifying that the vehicle 500 is being driven, the wearable electronic device 401 may display remaining virtual objects excluding the at least one first virtual object and the at least one second virtual object among the at least one virtual object. Depending on implementation, according to an embodiment, when identifying that the vehicle 500 is being driven, the wearable electronic device 401 may not display any of the at least one virtual object. For example, the at least one first virtual object and the at least one second virtual object may include an object not related to driving of the vehicle 500. For example, the at least one first virtual object and the at least one second virtual object may include an object related to a function of displaying content (e.g., an image or a video) and an object related to a function of executing a music application of the wearable electronic device 401. For example, the at least one first virtual object and the at least one second virtual object may be configured by a user input or by the wearable electronic device 401. According to an embodiment, when identifying that the vehicle 500 is not being driven (No in operation 633), the wearable electronic device 401 may display the at least one first virtual object in an area proximate to a first portion of the steering wheel which is in contact with one hand in operation 637. For example, the at least one first virtual object may include a virtual object specified for the first portion.

Accordingly, the wearable electronic device 401 may not display at least one virtual object during driving, thereby providing the user with an environment enabling the user to concentrate on driving the vehicle.

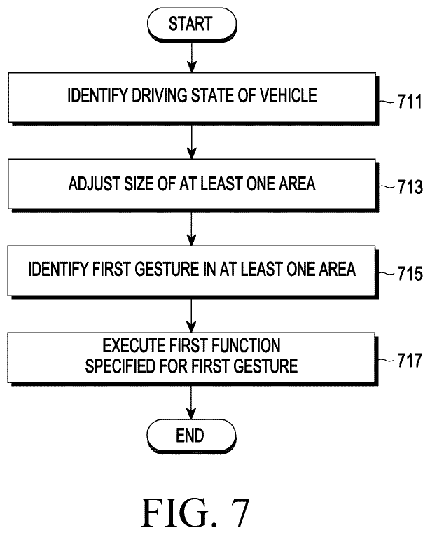

FIG. 7 is a flowchart illustrating an operation in which a wearable electronic device adjusts the size of at least one area, based on the driving state of a vehicle according to an embodiment.

Referring to FIG. 7, according to an embodiment, in operation 711, a wearable electronic device 401 (e.g., the wearable electronic device 401 of FIG. 4) may identify the driving state of a vehicle. For example, the driving state may include the driving speed of the vehicle 500 (e.g., the vehicle 500 of FIG. 4) or the rotation angle of a steering wheel of the vehicle 500. According to an embodiment, the wearable electronic device 401 may obtain the driving speed of the vehicle 500 or the rotation angle of the steering wheel from a control device 501 (e.g., the control device 501 of FIG. 4). According to an embodiment, the wearable electronic device 401 may obtain the driving speed of the vehicle 500 or the rotation angle of the steering wheel through a camera 410.

According to an embodiment, in operation 713, the wearable electronic device 401 may adjust the size of at least one area for identifying a gesture of a user, based on a proximity state of the steering wheel of the vehicle 500 and the driving state of the vehicle 500.

According to an embodiment, the wearable electronic device 401 may reduce the size of the at least one area as the driving speed of the vehicle 500 increases. According to an embodiment, when identifying that the driving speed of the vehicle 500 is less than a first specified speed, the wearable electronic device 401 may configure the size of the at least one area to a first size. According to an embodiment, when identifying that the driving speed of the vehicle 500 is greater than the first specified speed, the wearable electronic device 401 may configure the size of the at least one area to a second size smaller than the first size. For example, the first specified speed may refer to 30 km/h. However, this example is for illustration, and the first specified speed may not be limited to this example. For example, the first specified speed may be automatically configured by the wearable electronic device 401, or may be configured by the user. For example, the first specified speed may refer to the driving speed of the vehicle 500 for determining the size of the at least one area.

According to an embodiment, the wearable electronic device 401 may reduce the size of the at least one area as the rotation angle of the steering wheel of the vehicle 500 increases. According to an embodiment, when identifying that the rotation angle of the steering wheel is less than a first specified angle, the wearable electronic device 401 may configure the size of the at least one area to the first size. According to an embodiment, when identifying that the rotation angle of the steering wheel is greater than the first specified angle, the wearable electronic device 401 may configure the size of the at least one area to the second size smaller than the first size. For example, the first specified angle may refer to 10 degrees. However, this example is for illustration, and the first specified angle may not be limited to this example. For example, the first specified angle may be automatically configured by the wearable electronic device 401, or may be configured by the user.

According to an embodiment, the wearable electronic device 401 may adjust the size of at least one virtual object through a display 460 (e.g., the display 460 of FIG. 4) as adjusting the size of the at least one area. For example, the wearable electronic device 401 may configure a ratio of adjusting the size of the at least one area to be the same as a ratio of adjusting the size of the at least one object.

According to an embodiment, in operation 715, the wearable electronic device 401 may identify a first gesture in the at least one area. For example, the first gesture may include a gesture to execute a first function specified for at least one function.

According to an embodiment, in operation 717, the wearable electronic device 401 may execute the first function specified for the first gesture.

Accordingly, when the driving speed of the vehicle 500 or the rotation angle of the steering wheel is large, the wearable electronic device 401 may reduce the size of the area for identifying a gesture to execute a function related to the wearable electronic device 401 or the control device 501 of the vehicle 500, thereby providing the user with an environment enabling the user to concentrate on driving.

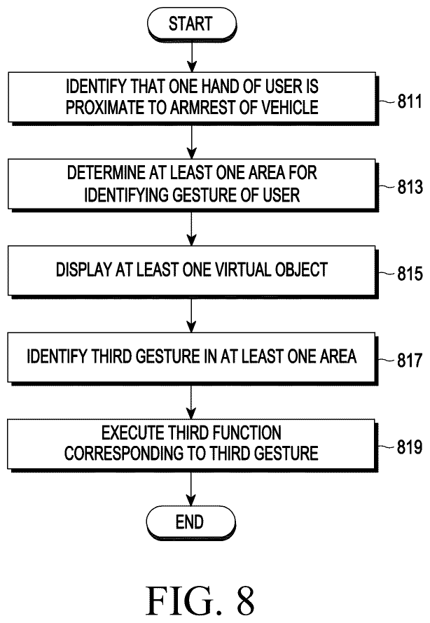

FIG. 8 is a flowchart illustrating an operation in which a wearable electronic device displays at least one virtual object in an area adjacent to an armrest according to an embodiment.

Referring to FIG. 8, according to an embodiment, in operation 811, a wearable electronic device 401 (e.g., the wearable electronic device 401 of FIG. 4) may identify that one hand of a user is proximate to (e.g., in contact with) an armrest of a vehicle 500 (e.g., the vehicle 500 of FIG. 4).

According to an embodiment, in operation 813, the wearable electronic device 401 may determine at least one area for identifying a gesture of the user. For example, the at least one area may include the armrest or an area proximate to the armrest.

Depending on implementation, according to an embodiment, the size of the at least one area may be adjusted based on the driving state of the vehicle 500. According to an embodiment, the wearable electronic device 401 may adjust the size of the at least one area to be reduced or increased as the speed of the vehicle 500 increases. According to an embodiment, the wearable electronic device 401 may adjust the size of the at least one area to be reduced or increased as the rotation angle of a steering wheel of the vehicle 500 increases.

According to an embodiment, in operation 815, the wearable electronic device 401 may display at least one virtual object.

According to an embodiment, the at least one object may include at least one virtual object related to the wearable electronic device 401. For example, the at least one virtual object may include at least one of an object related to a function of executing a call application of the wearable electronic device 401, an object related to a function of executing a music application of the wearable electronic device 401, an object related to a function of playing content (e.g., a video) stored in the wearable electronic device 401, or an object related to a function of establishing a short-range communication connection between the wearable electronic device 401 and an external electronic device.

According to an embodiment, the at least one virtual object may include at least one virtual object related to the vehicle 500. For example, the at least one virtual object may include at least one of an object related to a function of turning on a turn signal of the vehicle 500, an object related to a function of turning on an emergency light, an object related to a function of establishing a short-distance communication connection between a control device 501 and an external electronic device, or an object related to a function of displaying an image of an external environment of the vehicle 500 captured with a camera included in the vehicle 500. For example, the image of the external environment of the vehicle 500 captured with the camera included in the vehicle 500 may be obtained from the control device 501.

According to an embodiment, in operation 817, the wearable electronic device 401 may identify a third gesture in the at least one area. According to an embodiment, the wearable electronic device 401 may identify the third gesture, based on at least one of the movement direction or shape of a specific finger of the user. For example, the third gesture may refer to a gesture of unfolding the specific finger (e.g., thumb) and folding the other fingers. For example, the third gesture may refer to moving the specific finger from left to right a specific number of times. For example, the third gesture may refer to a gesture of bending the specific finger. For example, the third gesture may refer to rotating the specific finger a specific number of times. For example, the third gesture may refer to rotating the specific finger clockwise or counterclockwise a specific number of times. However, the above examples are for illustration, and the third gesture may not be limited to the above examples.

According to an embodiment, in operation 819, the wearable electronic device 401 may execute a function corresponding to the third gesture, based on identifying the third gesture of one hand of the user in the at least one area. For example, when identifying the third gesture corresponding to the at least one virtual object related to the wearable electronic device 401, the wearable electronic device 401 may execute a function corresponding to the at least one virtual object. For example, when identifying the third gesture corresponding to the at least one virtual object related to the vehicle 500, the wearable electronic device 401 may transmit a control signal to execute a function corresponding to the at least one virtual object to the control device 501.

According to an embodiment, after the third function corresponding to the third gesture is executed, when a fourth gesture is identified, the wearable electronic device 401 may execute a fourth function corresponding to the fourth gesture.

For example, the wearable electronic device 401 may display content, based on the third gesture. According to an embodiment, the wearable electronic device 401 may execute the function corresponding to the fourth gesture or transmit a control signal to the control device 501 to execute the function corresponding to the fourth gesture, based on identifying the fourth gesture in the at least one area, while displaying the content (e.g., a video). According to an embodiment, the wearable electronic device 401 may identify the fourth gesture, based on at least one of the movement direction or shape of a specific finger of the user. For example, the fourth gesture may refer to a gesture of the user unfolding index and middle fingers and folding the other fingers. According to an embodiment, when identifying the fourth gesture, the wearable electronic device 401 may display at least one object related to a function of adjusting volume of the content.

According to an embodiment, when identifying a fifth gesture of moving the index finger of the user from bottom to top, the wearable electronic device 401 may increase the volume of the content or transmit a control signal to increase the volume of the content to the control device 501. According to an embodiment, when identifying a sixth gesture of moving the index finger of the user from top to bottom, the wearable electronic device 401 may reduce the volume of the content or transmit a control signal to reduce the volume of the content to the control device 501. However, the above examples are for illustration, and the fourth gesture, the fifth gesture, and the sixth gesture may not be limited to the above examples.

Depending on implementation, according to an embodiment, the wearable electronic device 401 may identify that the hand of the user, identified in an area proximate to the steering wheel, moves to the area proximate to the armrest. According to an embodiment, the wearable electronic device 401 may determine that the at least one area for identifying the gesture of the user is the area proximate to the armrest instead of the area proximate to the steering wheel.

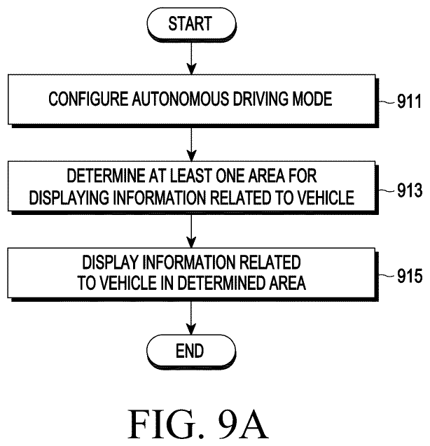

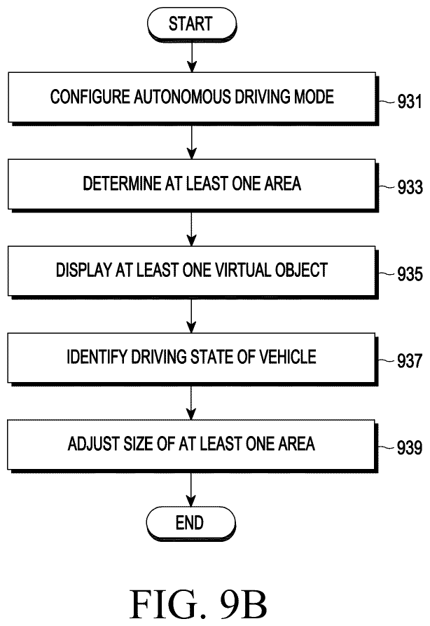

FIG. 9A is a flowchart illustrating an operation in which a wearable electronic device determines an area for displaying information related to a vehicle when an autonomous mode is configured according to an embodiment.

Referring to FIG. 9A, according to an embodiment, in operation 911, a control device 501 (e.g., the control device 501 of FIG. 4) may be configured in an autonomous driving mode of a vehicle 500 (e.g., the vehicle 500 of FIG. 4). According to an embodiment, the autonomous driving mode may include a first-stage autonomous driving mode, a second-stage autonomous driving mode, and a third-stage autonomous driving mode. For example, the first-stage autonomous driving mode, the second-stage autonomous driving mode, and the third-stage autonomous driving mode may be configured by a user input.

For example, the first-stage autonomous driving mode may include a stage in which the vehicle 500 is able to adjust a driving speed without user intervention. For example, the second-stage autonomous driving mode may include a stage in which the vehicle 500 is able to adjust a driving speed without user intervention and is able to maintain a regular distance from a vehicle in front. For example, the third-stage autonomous driving mode may include a stage in which the vehicle 500 is able to adjust a driving speed, is able to maintain a regular distance from a vehicle in front, and is able to change a lane without user intervention. However, the above examples are for illustration, and stages of the autonomous driving mode may not be limited thereto. According to an embodiment, when configured in the autonomous driving mode, the control device 501 may transmit information about a stage of the autonomous driving mode to a wearable electronic device 401.

According to an embodiment, in operation 913, the wearable electronic device 401 (e.g., the wearable electronic device 401 of FIG. 4) may determine at least one area for displaying information related to the vehicle 500, based on the stage of the autonomous driving mode.

For example, when identifying that the autonomous driving mode is in a first stage, the wearable electronic device 401 may display information related to the vehicle 500 in a lower area of the entire area of a windshield of the vehicle 500. For example, the lower area of the windshield of the vehicle may include a center information display (CID) or a head-up display (HUD).

For example, when identifying that the autonomous driving mode is in a second stage, the wearable electronic device 401 may display the information related to the vehicle 500 in at least a portion including the lower area of the windshield of the vehicle 500 among the entire area of the windshield of the vehicle 500. According to an embodiment, a second size of the area in which the information related to the vehicle 500 is displayed when the autonomous driving mode is in the second stage may be greater than a first size of the area in which the information related to the vehicle 500 is displayed when the autonomous driving mode is in the first stage.

For example, identifying that the autonomous driving mode is in a third stage, the wearable electronic device 401 may display the information related to the vehicle 500 in the entire area of the windshield of the vehicle 500. According to an embodiment, a third size of the area in which the information related to the vehicle 500 is displayed when the autonomous driving mode is in the third stage may be greater than the first size and the second size.

According to an embodiment, in operation 915, the wearable electronic device 401 may display the information related to the vehicle 500 in the determined area. According to an embodiment, the information related to the vehicle 500 may include information about a driving direction, information about a driving speed, dashboard information, navigation information, or content information. According to an embodiment, the wearable electronic device 401 may display different information in each stage of the autonomous driving mode. For example, according to an embodiment, the wearable electronic device 401 may display the content information only when the autonomous driving mode is in the third stage.

Depending on implementation, according to an embodiment, the wearable electronic device 401 may identify the driving state of the vehicle 500. According to an embodiment, the wearable electronic device 401 may adjust the size of the area for displaying the information related to the vehicle 500, based on the driving speed of the vehicle 500. According to an embodiment, the wearable electronic device 401 may adjust the size of the area for displaying the information related to the vehicle 500, based on the rotation angle of a steering wheel of the vehicle 500.

For example, according to an embodiment, when the autonomous driving mode is in the first stage and the driving speed corresponds to a specified speed, the wearable electronic device 401 may adjust the size of the area for displaying the information related to the vehicle to a size smaller or greater than the first size. For example, according to an embodiment, when the autonomous driving mode is in the second stage and the driving speed corresponds to the specified speed, the wearable electronic device 401 may adjust the size of the area for displaying the information related to the vehicle to a size smaller or greater than the second size. For example, according to an embodiment, when the autonomous driving mode is in the third stage and the driving speed corresponds to the specified speed, the wearable electronic device 401 may adjust the size of the area for displaying the information related to the vehicle to a size smaller or greater than the third size.

For example, according to an embodiment, when the autonomous driving mode is in the first stage and the rotation angle of the steering wheel corresponds to a specified angle, the wearable electronic device 401 may adjust the size of the area for displaying the information related to the vehicle to a size smaller or greater than the first size. For example, according to an embodiment, when the autonomous driving mode is in the second stage and the rotation angle of the steering wheel corresponds to the specified angle, the wearable electronic device 401 may adjust the size of the area for displaying the information related to the vehicle to a size smaller or greater than the second size. For example, according to an embodiment, when the autonomous driving mode is in the third stage and the rotation angle of the steering wheel corresponds to the specified angle, the wearable electronic device 401 may adjust the size of the area for displaying the information related to the vehicle to a size smaller or greater than the third size.

FIG. 9B is a flowchart illustrating an operation in which a wearable electronic device determines at least one area for executing a function related to a vehicle when an autonomous mode is configured according to an embodiment.

Referring to FIG. 9B, according to an embodiment, in operation 931, a control device 501 (e.g., the control device 501 of FIG. 4) may be configured in an autonomous driving mode of a vehicle 500. According to an embodiment, the autonomous driving mode may include a first-stage autonomous driving mode, a second-stage autonomous driving mode, and a third-stage autonomous driving mode.

According to an embodiment, in operation 933, a wearable electronic device 401 (e.g., the wearable electronic device 401 of FIG. 4) may determine at least one area for identifying a gesture of a user.

According to an embodiment, in operation 935, the wearable electronic device 401 may display at least one virtual object corresponding to at least one function related to the vehicle 500 or the wearable electronic device 401.

For example, when the autonomous driving mode is in a first stage, the at least one area for identifying the gesture of the user and an area for displaying the at least one virtual object may include a lower area of a windshield of the vehicle among the entire area of the windshield of the vehicle 500. For example, when the autonomous driving mode is in a second stage, the at least one area for identifying the gesture of the user and the area for displaying the at least one virtual object may include at least a portion including the lower area of the windshield of the vehicle 500 among the entire area of the windshield of the vehicle 500. For example, when the autonomous driving mode is in a third stage, the at least one area for identifying the gesture of the user and the area for displaying the at least one virtual object may be the entire area of the windshield of the vehicle 500.

According to an embodiment, the at least one virtual object may include at least one virtual object to control the wearable electronic device 401. For example, the at least one virtual object may include at least one of an object related to a function of executing a call application of the wearable electronic device 401, an object related to a function of executing a music application of the wearable electronic device 401, an object related to a function of playing content (e.g., a video) stored in the wearable electronic device 401, or an object related to a function of establishing a short-range communication connection between the wearable electronic device 401 and an external electronic device.

According to an embodiment, the at least one virtual object may include at least one virtual object related to the vehicle 500. For example, the at least one virtual object may include at least one of an object related to a function of turning on a turn signal of the vehicle 500, an object related to a function of turning on an emergency light, an object related to a function of establishing a short-distance communication connection between the control device 501 and an external electronic device, or an object related to a function of displaying an image of an external environment of the vehicle 500 captured with a camera included in the vehicle 500.

Depending on implementation, according to an embodiment, different virtual objects may be displayed on a display 460 (e.g., the display 460 of FIG. 4) in each stage of the autonomous driving mode of the vehicle 500.

According to an embodiment, in operation 937, the wearable electronic device 401 may identify the driving state of the vehicle 500 (e.g., the vehicle 500 of FIG. 4).

According to an embodiment, in operation 939, the wearable electronic device 401 may adjust the size of the at least one area, based on the driving state of the vehicle 500.

According to an embodiment, the wearable electronic device 401 may reduce the size of the at least one area as the driving speed of the vehicle 500 increases. According to an embodiment, the wearable electronic device 401 may reduce the size of the at least one area as the rotation angle of a steering wheel of the vehicle 500 increases.

Depending on implementation, according to an embodiment, when identifying that the autonomous driving mode of the vehicle 500 is in the third stage, the wearable electronic device 401 may not adjust the size of the at least one area regardless of the driving state of the vehicle 500. However, this example is for illustration, and the stage of the autonomous driving mode in which the size of the at least one area is not adjusted may be configured based on a user input.

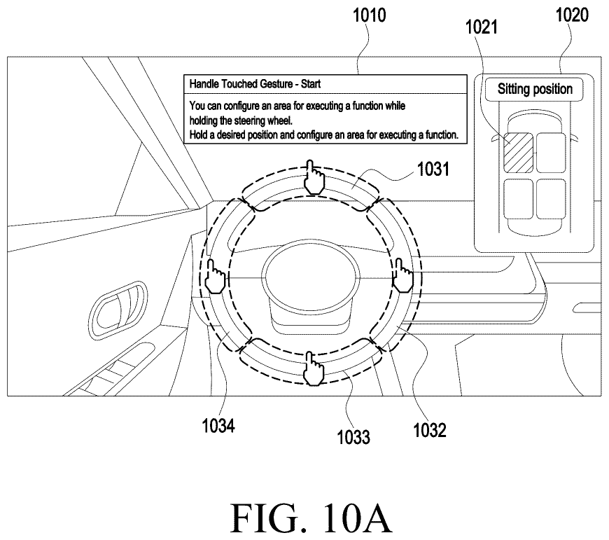

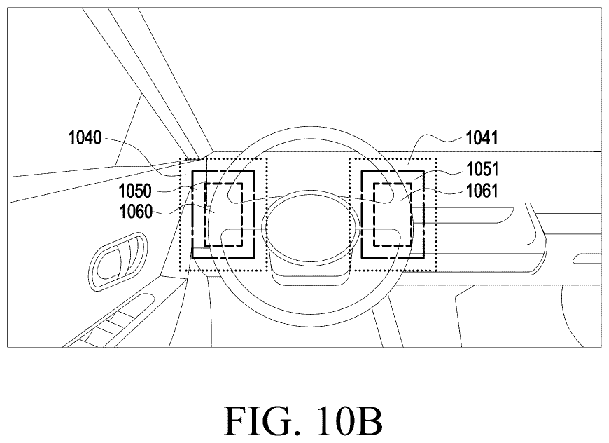

FIG. 10A illustrates an operation in which a wearable electronic device determines at least one virtual object corresponding to at least one area according to an embodiment.

Referring to FIG. 10A, according to an embodiment, a wearable electronic device 401 (e.g., the wearable electronic device 401 of FIG. 4) may identify the position of a user in a vehicle 500 (e.g., the vehicle 500 of FIG. 4) which the user boards. According to an embodiment, the wearable electronic device 401 may display information 1020 and 1021 about the identified position of the user. According to an embodiment, the wearable electronic device 401 may identify the position of the user as a driver seat.

According to an embodiment, the wearable electronic device 401 may display guide information (e.g., You can configure an area for executing a function while holding the steering wheel. Hold a desired position and configure an area for executing a function) 1010 to determine at least one area for identifying a gesture of the user.

According to an embodiment, when one hand of the user is proximate to (e.g., in contact with) an upper portion 1031 of the steering wheel among the upper portion 1031 of the steering wheel, a right portion 1032 of the steering wheel, a lower portion 1033 of the steering wheel, and a left portion 1034 of the steering wheel, the wearable electronic device 401 may display at least one virtual object to be matched to the upper portion 1031 of the steering wheel in an area adjacent to the upper portion 1031 of the steering wheel.

According to an embodiment, when a first virtual object included in the at least one virtual object is selected, the wearable electronic device 401 may match the first virtual object to the upper portion 1031 of the steering wheel. According to an embodiment, when a plurality of virtual objects is selected, the wearable electronic device 401 may match the plurality of virtual objects to the upper portion 1031 of the steering wheel. According to an embodiment, when one hand of the user is proximate to the upper portion 1031 of the steering wheel, the wearable electronic device 401 may display the first virtual object or the plurality of virtual objects in the area adjacent to the upper portion 1031 of the steering wheel.

According to an embodiment, when one hand of the user is proximate to (e.g., in contact with) the right portion 1032 of the steering wheel, the wearable electronic device 401 may display at least one virtual object to be matched to the right portion 1032 of the steering wheel in an area adjacent to the right portion 1032 of the steering wheel. According to an embodiment, when a second virtual object is selected among the at least one virtual object, the wearable electronic device 401 may match the second virtual object to the right portion 1032 of the steering wheel. According to an embodiment, when one hand of the user is proximate to the right portion 1032 of the steering wheel, the wearable electronic device 401 may display the second virtual object in the area adjacent to the right portion 1032 of the steering wheel. According to an embodiment, when a plurality of virtual objects is matched to the right portion 1032 of the steering wheel, the wearable electronic device 401 may display the plurality of virtual objects in the area adjacent to the right portion 1032 of the steering wheel.

According to an embodiment, when one hand of the user is proximate to the lower portion 1033 of the steering wheel, the wearable electronic device 401 may display at least one virtual object to be matched to the lower portion 1033 of the steering wheel in an area adjacent to the lower portion 1033 of the steering wheel. According to an embodiment, when a third virtual object is selected among the at least one virtual object, the wearable electronic device 401 may match the third virtual object to the lower portion 1033 of the steering wheel. According to an embodiment, when one hand of the user is proximate to the lower portion 1033 of the steering wheel, the wearable electronic device 401 may display the third virtual object in the area adjacent to the lower portion 1033 of the steering wheel. According to an embodiment, when a plurality of virtual objects is matched to the lower portion 1033 of the steering wheel, the wearable electronic device 401 may display the plurality of virtual objects in the area adjacent to the lower portion 1033 of the steering wheel.

According to an embodiment, when one hand of the user is proximate to the left portion 1034 of the steering wheel, the wearable electronic device 401 may display at least one virtual object to be matched to the left portion 1034 of the steering wheel in area adjacent to the left portion 1034 of the steering wheel. According to an embodiment, when a fourth virtual object is selected among the at least one virtual object, the wearable electronic device 401 may match the fourth virtual object to the left portion 1034 of the steering wheel. According to an embodiment, when one hand of the user is proximate to the left portion 1034 of the steering wheel, the wearable electronic device 401 may display the fourth virtual object in the area adjacent to the left portion 1034 of the steering wheel. According to an embodiment, when a plurality of virtual objects is matched to the left portion 1034 of the steering wheel, the wearable electronic device 401 may display the plurality of virtual objects in the area adjacent to the lower portion 1033 of the steering wheel.

According to an embodiment, the first virtual object, the second virtual object, the third virtual object, and the fourth virtual object may be the same as or different from each other.

Depending on implementation, according to an embodiment, when both hands of the user are proximate to the left portion 1034 of the steering wheel and the right portion 1032 of the steering wheel, respectively, the wearable electronic device 401 may display the at least one virtual object to be matched to the left portion 1034 of the steering wheel and the at least one virtual object to be matched to the right portion 1032 of the steering wheel. According to an embodiment, the wearable electronic device 401 may match the fourth virtual object to the left portion 1034 and the second virtual object to the right portion 1032 of the steering wheel, based on a user input. According to an embodiment, the wearable electronic device 401 may display the fourth virtual object in the area adjacent to the left portion 1034 and the second virtual object in the right portion 1032 only when both hands of the user are proximate to the left portion 1034 of the steering wheel and the right portion 1032 of the steering wheel, respectively. According to an embodiment, when identifying that only one hand of the user is proximate to the left portion 1034 of the steering wheel or the right portion 1032 of the steering wheel, the wearable electronic device 401 may not display the fourth virtual object in the area adjacent to the left portion 1034 and may not display the second virtual object in the right portion 1032.

According to an embodiment, when both hands of the user are proximate to the upper portion 1031 of the steering wheel and the lower portion 1033 of the steering wheel, respectively, the wearable electronic device 401 may display the at least one virtual object to be matched to the upper portion 1031 of the steering wheel and the at least one virtual object to be matched to the lower portion 1033 of the steering wheel. According to an embodiment, the wearable electronic device 401 may match the first virtual object to the upper portion 1031 and the third virtual object to the lower portion 1033 of the steering wheel, based on a user input. According to an embodiment, the wearable electronic device 401 may display the first virtual object in the area adjacent to the upper portion 1031 and the third virtual object in the lower portion 1033 of the steering wheel only when both hands of the user are proximate to the upper portion 1031 of the steering wheel and the lower portion 1033 of the steering wheel, respectively. According to an embodiment, when identifying that only one hand of the user is proximate to the upper portion 1031 of the steering wheel or the lower portion 1033 of the steering wheel, the wearable electronic device 401 may not display the first virtual object in the area adjacent to the upper portion 1031 and may not display the third virtual object in the lower portion 1033.

FIG. 10B illustrates an operation in which a wearable electronic device determines at least one area for identifying a gesture of a user according to an embodiment.

Referring to FIG. 10B, according to an embodiment, a wearable electronic device 401 (e.g., the wearable electronic device 401 of FIG. 4) may determine at least one area 1040, 1041, 1050, 1051, 1060, and 1061 for identifying a gesture of a user, based on the driving state of a vehicle 500 (e.g., the vehicle 500 of FIG. 4). According to an embodiment, the at least one region 1040, 1041, 1050, 1051, 1060, and 1061 may be configured with various sizes and various shapes, without being limited to sizes and shapes illustrated in FIG. 10B.

For example, according to an embodiment, when identifying that the driving speed of the vehicle 500 is less than a first speed, the wearable electronic device 401 may determine that the at least one area is at least one first area 1040 and 1041. For example, according to an embodiment, when identifying that the driving speed of the vehicle 500 is greater than the first speed and less than a second speed, the wearable electronic device 401 may determine that the at least one area is at least one second area 1050 and 1051. For example, according to an embodiment, when identifying that the driving speed of the vehicle 500 is greater than the second speed, the wearable electronic device 401 may determine that the at least one area is at least one third area 1060 and 1061. For example, the second speed may be greater than the first speed, and a third speed may include a speed greater than the second speed.

For example, the size of the at least one first area 1040 and 1041 may be greater than the size of the at least one second area 1050 and 1051 and the size of the at least one third area 1060 and 1061. For example, the size of the at least one second area 1050 and 1051 may be greater than the size of the third at least one area 1060 and 1061.

For example, according to an embodiment, when identifying that the rotation angle of a steering wheel of the vehicle 500 is less than a first angle, the wearable electronic device 401 may determine that the at least one area is the at least one first area 1040 and 1041. For example, according to an embodiment, when identifying that the rotation angle of the steering wheel of the vehicle 500 is greater than the first angle and less than a second angle, the wearable electronic device 401 may determine that at least one area is the at least one second area 1050 and 1051. For example, according to an embodiment, when identifying that the rotation angle of the steering wheel of the vehicle 500 is greater than the second angle, the wearable electronic device 401 may determine that the at least one area is the at least one third area 1060 and 1061. For example, the second angle may be greater than the first angle, and a third angle may include an angle greater than the second angle. For example, the size of the at least one first area 1040 and 1041 may be greater than the size of the at least one second area 1050 and 1051 and the size of the at least one third area 1060 and 1061. For example, the size of the at least one second area 1050 and 1051 may be greater than the size of the at least one third area 1060 and 1061.

According to an embodiment, the wearable electronic device 401 may determine the at least one area, based on the gaze of the user. According to an embodiment, the wearable electronic device 401 may identify the gaze of the user through a camera 410 (e.g., the camera 410 of FIG. 4).

For example, when identifying that the gaze of the user is directed to the steering wheel, the wearable electronic device 401 may determine that the at least one area is the at least one first area 1040 and 1041.

For example, when identifying that the gaze of the user is directed to a lower area of the entire area of a windshield of the vehicle 500, the wearable electronic device 401 may determine that the at least one area is the at least one second area 1050 and 1051.

For example, when identifying that the gaze of the user is directed to an upper area of the entire area of the windshield, the wearable electronic device 401 may determine that the at least one area is the at least one third area 1060 and 1061. However, the above examples are for illustration, and embodiments of the disclosure may determine, based on the gaze of the user, the at least one area in various manners.

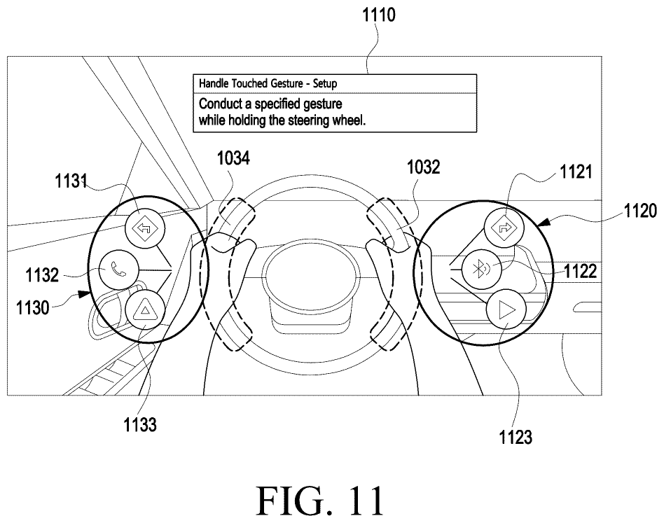

FIG. 11 illustrates an operation in which a wearable electronic device displays at least one object according to an embodiment.

Referring to FIG. 11, a wearable electronic device 401 (e.g., the wearable electronic device 401 of FIG. 4) may display guide information 1110 (e.g., Conduct a specified gesture while holding the steering wheel) to display a plurality of virtual objects to execute a function related to a vehicle 500 (e.g., the vehicle 500 of FIG. 4).

According to an embodiment, the wearable electronic device 401 may display a first virtual object 1131, a second virtual object 1132, and a third virtual object 1133 in a first area 1130 adjacent to a left portion 1034 of a steering wheel, based on identifying that one hand of a user is proximate to the left portion 1034 of the steering wheel. The first virtual object 1131, the second virtual object 1132, and the third virtual object 1133 may refer to virtual objects specified in the left portion 1034 of the steering wheel. For example, the first virtual object 1131 may refer to an object related to a left turn signal, the second virtual object 1132 may refer to an object related to a call application, and the third virtual object 1133 may refer to an object related to an emergency light. According to an embodiment, the first area 1130 may refer to an area for identifying a gesture of a user.

According to an embodiment, the wearable electronic device 401 may display a fourth virtual object 1121, a fifth virtual object 1122, and a sixth virtual object 1123 in a second area 1120 adjacent to a right portion 1032 of the steering wheel, based on identifying that the other hand of the user is proximate to the right portion 1032 of the steering wheel. The fourth virtual object 1121, the fifth virtual object 1122, and the sixth virtual object 1123 may refer to virtual objects specified in the right portion 1032 of the steering wheel. For example, the fourth virtual object 1121 may refer to an object related to a right turn signal, the fifth virtual object 1122 may refer to an object related to a short-range communication connection, and the sixth virtual object 1123 may refer to an object related to content display. According to an embodiment, the second area 1120 may refer to an area for identifying a gesture of a user.

For example, the object related to the short-range communication connection may refer to an object for performing a short-range communication connection between an external electronic device connected to a control device 501 and the wearable electronic device 401. For example, the object related to the short-range communication connection may also refer to an object for performing a short-range communication connection between the control device 501 and an external electronic device.

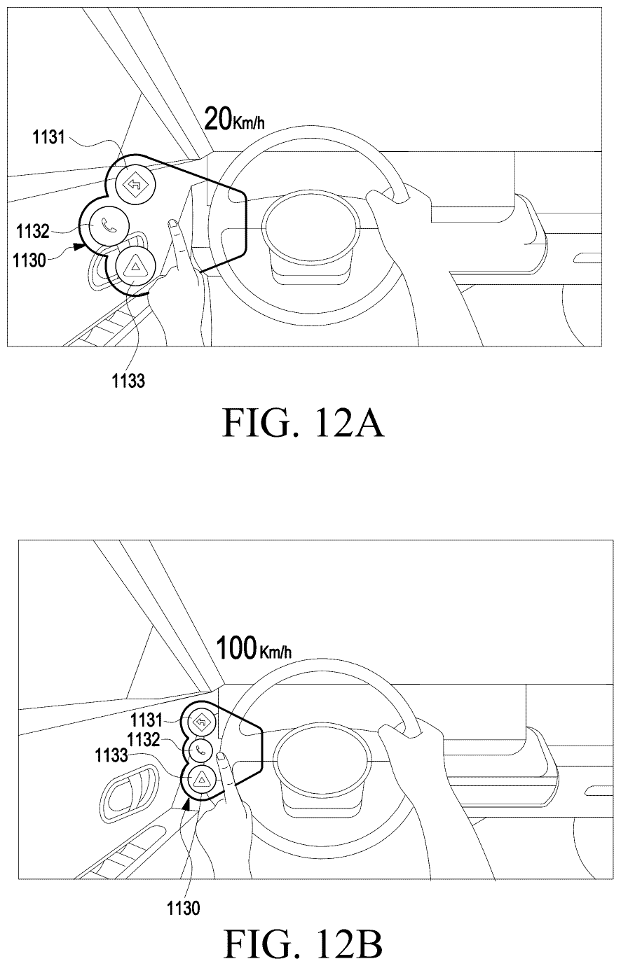

FIGS. 12A and 12B illustrate an operation in which a wearable electronic device adjusts the size of at least one area, based on the driving speed of a vehicle according to an embodiment.

Referring to FIG. 12A, according to an embodiment, a wearable electronic device 401 (e.g., the wearable electronic device 401 of FIG. 4) may identify that one hand of a user is in contact with (e.g., proximate to) a right portion of a steering wheel of a vehicle 500 (e.g., the vehicle 500 of FIG. 4).

According to an embodiment, the wearable electronic device 401 may identify that the driving speed of the vehicle 500 is 20 km/h. According to an embodiment, the wearable electronic device 401 may obtain the driving speed of the vehicle 500 from a control device 501 (e.g., the control device 501 of FIG. 4).

According to an embodiment, the wearable electronic device 401 may identify the size of each of a first virtual object 1131, a second virtual object 1132, and a third virtual object 1133 which are displayed, based on identifying that the driving speed is less than a first specified speed (e.g., 30 km/h).

According to an embodiment, the wearable electronic device 401 may identify the size of an area 1130 for identifying a gesture of the user, based on the driving speed. According to an embodiment, the wearable electronic device 401 may display the area 1130 for identifying the gesture of the user.

According to an embodiment, although FIG. 12A shows that the first virtual object 1131, the second virtual object 1132, and the third virtual object 1133 are displayed in the area 1130 for identifying the gesture of the user, the first virtual object 1131, the second virtual object 1132, and the third virtual object 1133 may be displayed in an area other than the area 1130 for identifying the gesture of the user.

According to an embodiment, when identifying a first gesture of the user in the area 1130 for identifying the gesture of the user, the wearable electronic device 401 may identify that there is an input to a virtual object corresponding to the first gesture among the first virtual object 1131, the second virtual object 1132, and the third virtual objects 1133.

Depending on implementation, according to an embodiment, even though the first virtual object 1131, the second virtual object 1132, and the third virtual object 1133 are displayed in the area other than the area 1130 for identifying the gesture of the user, when identifying a user gesture in an area in which the first virtual object 1131 is displayed, the wearable electronic device 401 may identify that there is an input to the first virtual object 1131. According to an embodiment, when identifying a user gesture in an area in which the second virtual object 1132 is displayed, the wearable electronic device 401 may identify that there is an input to the second virtual object 1132. According to an embodiment, identifying a user gesture in an area in which the third virtual object 1133 is displayed, the wearable electronic device 401 may identify that there is an input to the third virtual object 1133.

Referring to FIG. 12B, according to an embodiment, the wearable electronic device 401 may identify that the driving speed of the vehicle 500 is 100 km/h. According to an embodiment, the wearable electronic device 401 may display the size of the first virtual object 1131, the second virtual object 1132, and the third virtual object 1133 in a case where the driving speed is greater than the first specified speed (e.g., 30 km/h) to be smaller than the size of the first virtual object 1131, the second virtual object 1132, and the third virtual object 1133 in a case where the driving speed is less than the first specified speed, based on identifying that the driving speed is greater than the first specified speed (e.g., 30 km/h).

According to an embodiment, the wearable electronic device 401 may identify the area 1130 for identifying the gesture of the user, based on the driving speed. According to an embodiment, the wearable electronic device 401 may display the area 1130 for identifying the gesture of the user. According to an embodiment, the wearable electronic device 401 may adjust the size of the area 1130 for identifying the gesture of the user in a case where the driving speed is greater than the first specified speed (e.g., 30 km/h) to be smaller than the size of the area 1130 for identifying the gesture of the user in a case where the driving speed is less than the first specified speed (e.g., 30 km/h).

According to an embodiment, as the driving speed increases, the wearable electronic device 401 may reduce the size of the first virtual object 1131, the second virtual object 1132, and the third virtual object 1133. According to an embodiment, as the driving speed increases, the wearable electronic device 401 may reduce the size of the area 1130 for identifying the gesture of the user. Accordingly, the wearable electronic device 401 may enable the user to concentrate on driving when the driving speed of the vehicle increases.

According to an embodiment, the wearable electronic device 401 may not display a virtual object (e.g., the second virtual object 1132) not related to driving of the vehicle 500, based on identifying that the driving speed of the vehicle 500 is greater than the first specified speed (e.g., 30 km/h). For example, a virtual object related to driving of the vehicle 500 may include an object related to a function of turning on an emergency light of the vehicle 500, an object related to a function of turning on a turn signal of the vehicle 500, or an object related to a function of displaying an image (or video) of an external environment of the vehicle 500 captured with a camera included in the vehicle 500.

According to an embodiment, the wearable electronic device 401 may not display the virtual object (e.g., the second virtual object 1132) not related to driving of the vehicle 500, based on identifying that the vehicle 500 is being driven.

According to an embodiment, even though identifying a gesture of selecting the virtual object (e.g., the second virtual object 1132) not related to driving of the vehicle 500, the wearable electronic device 401 may not execute a function related to the virtual object (e.g., the second virtual object 1132) not related to driving of the vehicle 500, based on identifying that the driving speed of the vehicle 500 is greater than the first specified speed (e.g., 30 km/h).

According to an embodiment, even though identifying a gesture of selecting the virtual object (e.g., the second virtual object 1132) not related to driving of the vehicle 500, the wearable electronic device 401 may not execute the function related to the virtual object (e.g., the second virtual object 1132) not related to driving of the vehicle 500, based on identifying that the vehicle 500 is being driven.

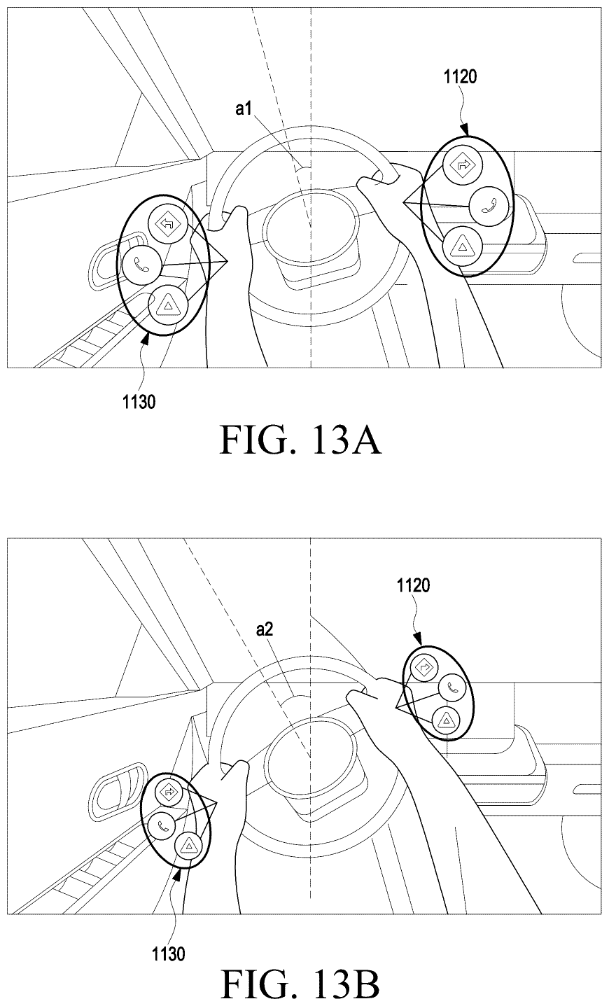

FIGS. 13A and 13B illustrate an operation in which a wearable electronic device adjusts the size of at least one area, based on the rotation angle of a steering wheel according to an embodiment.

Referring to FIG. 13A, according to an embodiment, a wearable electronic device 401 (e.g., the wearable electronic device 401 of FIG. 4) may identify that one hand of a user is proximate to (e.g., in contact with) a left portion of a steering wheel of a vehicle 500 (e.g., the vehicle 500 of FIG. 4) and the other hand of the user is proximate to (e.g., in contact with) a right portion of the steering wheel of the vehicle 500.

According to an embodiment, the wearable electronic device 401 may identify that the rotation angle of the steering wheel of the vehicle 500 is a1. For example, a1 may be 10 degrees.

According to an embodiment, the wearable electronic device 401 may identify the size of each of displayed virtual objects, based on identifying that a1 is less than a first specified size. For example, the first specified size may be 20 degrees.

According to an embodiment, the wearable electronic device 401 may identify the size of areas 1120 and 1130 for identifying a gesture of the user, based on the rotation angle of the steering wheel. According to an embodiment, the wearable electronic device 401 may display the areas 1120 and 1130 for identifying the gesture of the user.

According to an embodiment, although FIG. 13A shows that the virtual objects are displayed in the areas 1120 and 1130 for identifying the gesture of the user, the virtual objects may be displayed in an area other than the areas 1120 and 1130 for identifying the gesture of the user.

Referring to FIG. 13B, according to an embodiment, the wearable electronic device 401 may identify that the rotation angle of the steering wheel of the vehicle 500 is a2. For example, a2 may be 30 degrees.

According to an embodiment, the wearable electronic device 401 may display the size of a first area 1130 in which virtual objects are displayed in a case where a2 is greater than the first specified size to be smaller than the size of the first area 1130 in which the virtual objects are displayed in a case where a2 is less than the first specified size, based on identifying that a2 is greater than the first specified size.

According to an embodiment, the wearable electronic device 401 may display the size of a second area 1120 in which virtual objects are displayed in a case where a2 is greater than the first specified size to be smaller than the size of the second area 1120 in which the virtual objects are displayed in a case where a2 is less than the first specified size, based on identifying that a2 is greater than the first specified size.

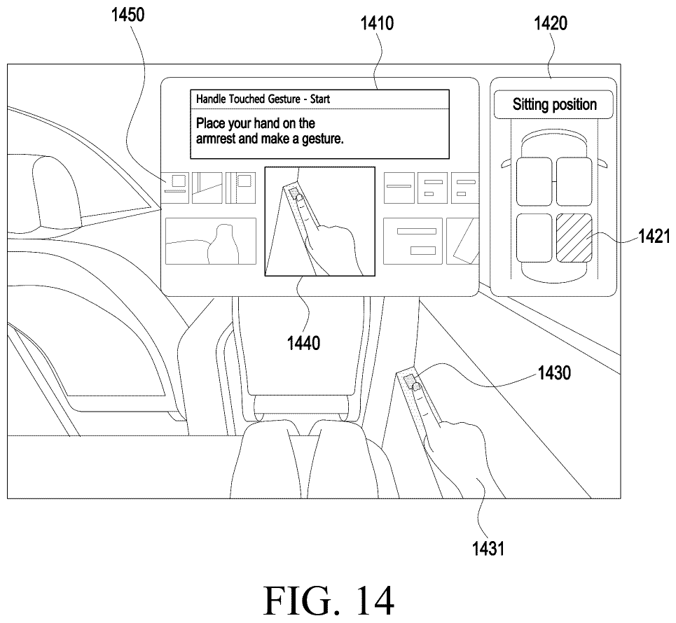

FIG. 14 illustrates an operation in which a wearable electronic device determines at least one area according to an embodiment.

Referring to FIG. 14, according to an embodiment, a wearable electronic device 401 (e.g., the wearable electronic device 401 of FIG. 4) may identify the position of a user in a vehicle 500 which the user boards. According to an embodiment, the wearable electronic device 401 may display information 1420 and 1421 about the identified position of the user. According to an embodiment, the wearable electronic device 401 may identify the position of the user as the right back seat.

According to an embodiment, the wearable electronic device 401 may display guide information (e.g., Place your hand on the armrest and make a gesture) 1410 and 1440 to determine at least one area for identifying a gesture of the user. For example, the guide information 1410 and 1440 may be displayed as text or an image.

According to an embodiment, the wearable electronic device 401 may identify that one hand 1431 of the user is in contact with a portion 1430 of an armrest by using a camera 410 (e.g., the camera 410 of FIG. 4).

According to an embodiment, the wearable electronic device 401 may display a virtual object 1450 related to content, based on identifying that the one hand 1431 of the user is in contact with the portion 1430 of the armrest. For example, an area in which the virtual object 1450 related to the content is displayed may include an upper portion of a field-of-view (FOV) area of the camera 410 or the wearable electronic device 401. However, this example is for illustration, and the area in which the virtual object 1450 related to the content is displayed may be an area adjacent to the portion 1430 of the armrest.

According to an embodiment, when identifying that a specific finger (e.g., index finger) of the one hand 1431 of the user is bent in the portion 1430 of the armrest, the wearable electronic device 401 may identify that there is an input to the virtual object 1450 related to the content. According to an embodiment, the wearable electronic device 401 may play content.

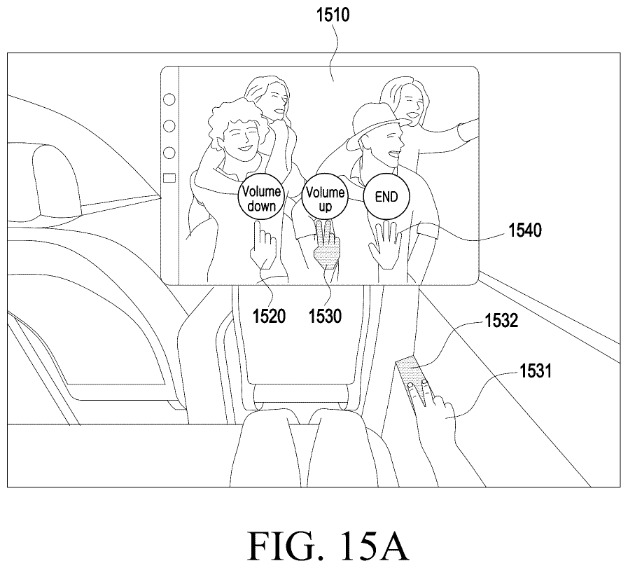

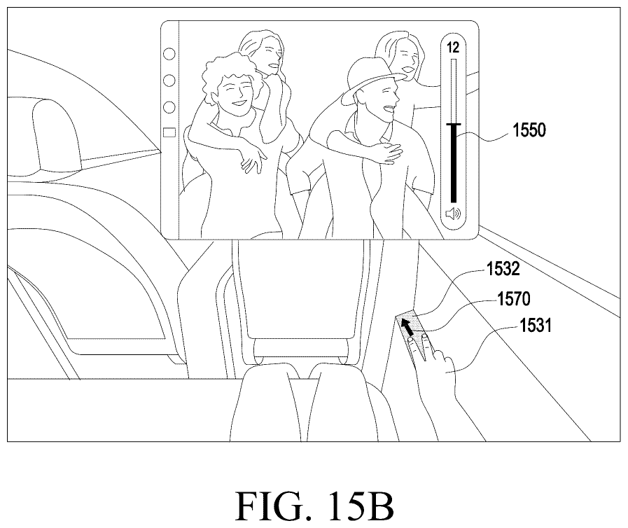

FIGS. 15A and 15B illustrate an operation in which a wearable electronic device displays at least one object according to an embodiment.

Referring to FIG. 15A, according to an embodiment, when identifying an input to a virtual object 1450 related to content, a wearable electronic device 401 may display content 1510 (e.g., an image or video).

According to an embodiment, the wearable electronic device 401 may display a plurality of virtual objects 1520, 1530, and 1540 on the content 1510. The plurality of virtual objects 1520, 1530, and 1540 may include an object 1520 related to a function of turning down volume of the content, an object 1530 related to a function of turning up volume of the content, and an object 1540 related to a function of ending playback of the content.

According to an embodiment, when identifying a gesture of hand 1531 specified for the object 1520 related to the function of turning down the volume of the content 1550 on an armrest 1532 or an area in which the content 1510 is displayed, the wearable electronic device 401 may turn down the volume of the content. For example, the gesture specified for the object 1520 related to the function of turning down the volume of the content may refer to a gesture of moving the index finger of the user's right hand from top to bottom with the index finger unfolded and the other fingers folded.

According to an embodiment, when identifying a gesture specified for the object 1540 related to the function of ending the playback of the content on the armrest 1530 or the area in which the content 1510 is displayed, the wearable electronic device 401 may end the playback of the content. For example, the gesture specified for the object 1540 related to the function of ending the playback of the content may refer to a state in which all right fingers of the user are unfolded.

According to an embodiment, when identifying a gesture specified for the object 1530 related to the function of turning up the volume of the content on the armrest 1530 or the area in which the content 1510 is displayed, the wearable electronic device 401 may turn up the volume of the content. For example, the gesture specified for the object 1530 related to the function of turning up the volume of the content may refer to a gesture of moving the index and middle fingers of the user's right hand in a bottom-to-top direction 1570 from with the index and middle fingers unfolded and the other fingers folded.

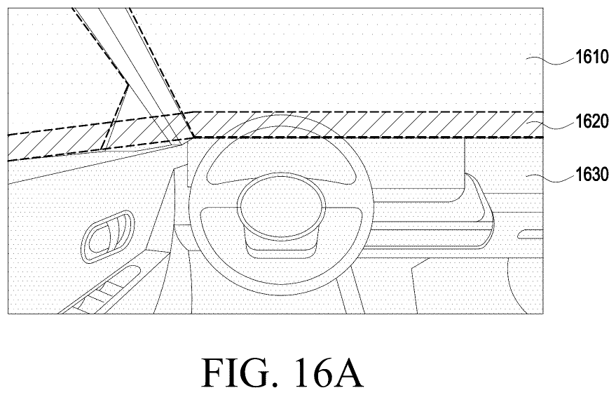

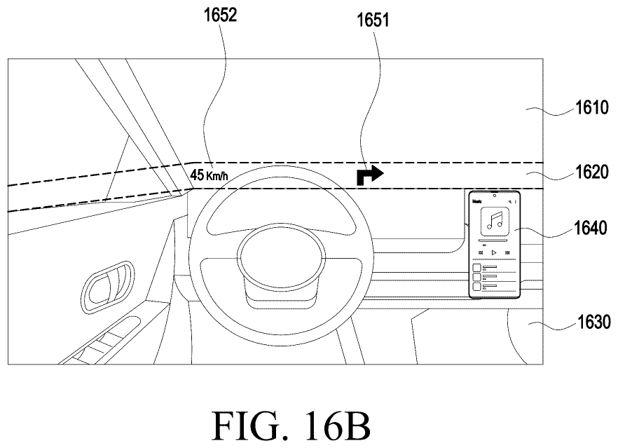

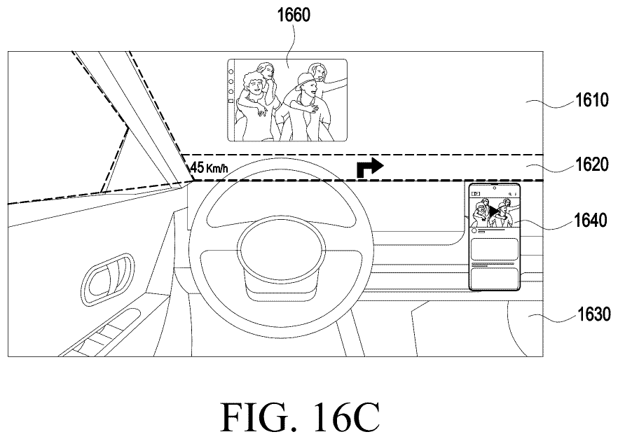

FIG. 16A illustrates an operation in which a wearable electronic device determines at least one area when a control device is configured in an autonomous driving mode of a vehicle according to an embodiment.

Referring to FIG. 16A, according to an embodiment, when a control device 501 (e.g., the control device 501 of FIG. 4) is configured in an autonomous driving mode of a vehicle 500 (e.g., the vehicle 500 of FIG. 4), a wearable electronic device 401 (e.g., the wearable electronic device 401 of FIG. 4) may display information related to the autonomous driving mode of the vehicle 500 in a specified area. For example, the autonomous driving mode may include a first-stage autonomous driving mode, a second-stage autonomous driving mode, and a third-stage autonomous driving mode.

For example, the first-stage autonomous driving mode may include a stage in which the vehicle is able to adjust a driving speed without user intervention. For example, the second-stage autonomous driving mode may include a stage in which the vehicle is able to adjust a driving speed without user intervention and is able to maintain a regular distance from a vehicle in front. For example, the third-stage autonomous driving mode may include a stage in which the vehicle is able to adjust a driving speed, is able to maintain a regular distance from a vehicle in front, and is able to change a lane without user intervention.

According to an embodiment, the specified area may include a first area 1610, a second area 1620, and a third area 1630.

According to an embodiment, when identifying that the autonomous driving mode is in a first stage, the wearable electronic device 401 may display information related to the vehicle in the second area 1620 of the vehicle.

According to an embodiment, when identifying that the autonomous driving mode is in a second stage, the wearable electronic device 401 may display the information related to the vehicle in the second area 1620 and the third area 1630 of the vehicle.

According to an embodiment, when identifying that the autonomous driving mode is in a third stage, the wearable electronic device 401 may display the information related to the vehicle in the first area 1610 of the vehicle, the second area 1620 of the vehicle, and the third area 1630 of the vehicle.

According to an embodiment, the information related to the vehicle may include information about a driving direction, information about a driving speed, dashboard information, navigation information, or content information. However, the above examples are for illustration, and the specified area and the information related to the vehicle may not be limited to the above examples.

FIG. 16B illustrates an operation in which a wearable electronic device displays information related to a vehicle when a control device is configured in a second-stage autonomous driving mode of a vehicle according to an embodiment.

Referring to FIG. 16B, according to an embodiment, a wearable electronic device 401 (e.g., the wearable electronic device 401 of FIG. 4) may identify that a control device 501 (e.g., the control device 501 of FIG. 4) is configured in a second-stage autonomous driving mode of a vehicle 500 (e.g., the vehicle 500 of FIG. 4).

According to an embodiment, when the second-stage autonomous driving mode is configured, the wearable electronic device 401 may display at least one of information about a driving direction 1651, information about a driving speed 1652, dashboard information, or navigation information in a second area 1620 of the vehicle.

According to an embodiment, when the second-stage autonomous driving mode is configured, the wearable electronic device 401 may display a virtual object 1640 representing a screen of an external electronic device which establishes a communication connection with the wearable electronic device 401 in a third area 1630. For example, the external electronic device may include a smartphone. For example, the virtual object 1640 may represent a screen of an application related to music playback installed on the external electronic device.

For example, when identifying an input to the virtual object 1640, the wearable electronic device 401 may play music corresponding to the input.

FIG. 16C illustrates an operation in which a wearable electronic device displays information related to a vehicle when a control device is configured in a third-stage autonomous driving mode of a vehicle according to an embodiment.

Referring to FIG. 16C, according to an embodiment, a wearable electronic device 401 (e.g., the wearable electronic device 401 of FIG. 4) may identify that a control device 501 (e.g., the control device 501 of FIG. 4) is configured in a third-stage autonomous driving mode of a vehicle 500 (e.g., the vehicle 500 of FIG. 4).

According to an embodiment, when the third-stage autonomous driving mode is configured, the wearable electronic device 401 may display at least one of information about a driving direction, information about a driving speed, dashboard information, or navigation information in a second area 1620 of the vehicle.

According to an embodiment, when the third-stage autonomous driving mode is configured, the wearable electronic device 401 may display a virtual object 1640 representing a screen of an external electronic device which establishes a communication connection with the wearable electronic device 401 in a third area 1630. For example, the external electronic device may include a smartphone. For example, the virtual object 1640 may represent a screen of an application related to video playback installed on the external electronic device.

For example, when identifying an input to the virtual object 1640, the wearable electronic device 401 may play a video corresponding to the input.

According to an embodiment, when the third-stage autonomous driving mode is configured, the wearable electronic device 401 may display a screen 1660 for the video in a first area 1610. According to an embodiment, the screen 1660 for the video may be displayed in an area proximate to a steering wheel in the first area 1610.

According to an embodiment, a wearable electronic device may include a camera, a display, communication circuitry, a processor, and memory storing instructions.

According to an embodiment, the wearable electronic device may establish a communication connection with a control device included in a vehicle through the communication circuitry.

According to an embodiment, the wearable electronic device may identify the state of a user in the vehicle through the camera.

According to an embodiment, the wearable electronic device may identify the driving state of the vehicle.

According to an embodiment, the wearable electronic device may determine at least one area for identifying a gesture of the user, based on at least one of the state of the user or the driving state.

According to an embodiment, the wearable electronic device may execute a first function corresponding to a first gesture among at least one function, based on identifying the first gesture of the user in the at least one area.

According to an embodiment, the wearable electronic device may determine the state of the user, based on the position of the user in the vehicle boarded by the user.

According to an embodiment, the wearable electronic device may display at least one virtual object related to the at least one function, based on identifying that one hand of the user is proximate to a first portion of a steering wheel of the vehicle.

According to an embodiment, the wearable electronic device may execute the first function, based on identifying the first gesture of the one hand in a first area proximate to the first portion among the at least one area.

According to an embodiment, the wearable electronic device may determine a first area corresponding to a position distanced from the steering wheel of the vehicle by a first specified distance among the at least one area, based on identifying that a driving speed of the vehicle is a first speed.

According to an embodiment, the wearable electronic device may determine a second area corresponding to a position distanced from the steering wheel of the vehicle by a second specified distance that is smaller than the first specified distance among the at least one area, based on identifying that the driving speed of the vehicle is a second speed greater than the first speed.

According to an embodiment, the wearable electronic device may display at least one virtual object related to the at least one function, based on identifying that one hand of the user is proximate to an armrest of the vehicle.

According to an embodiment, the wearable electronic device may display, based on identifying that the vehicle is being driven, at least one virtual object related to the at least one function when both hands of the user are proximate to the steering wheel of the vehicle.

According to an embodiment, the wearable electronic device may display, based on identifying that the vehicle is stopped, the at least one virtual object related to the at least one function even though both hands of the user are not proximate to the steering wheel of the vehicle.

According to an embodiment, the wearable electronic device may determine a size of the least one area as a first size when identifying that a driving speed of the vehicle is a first speed less than or equal to a first specified speed, and the wearable electronic device may determine the size of the least one area as a second size smaller than the first size when identifying that the driving speed of the vehicle is a second speed greater than the first specified speed.

According to an embodiment, the wearable electronic device may determine a size of the at least one area as a first size when identifying that a rotation angle of a steering wheel of the vehicle is a first angle less than or equal to a first specified angle, and the wearable electronic device may determine the size of the at least one area as a second size smaller than the first size when identifying that the rotation angle of the steering wheel of the vehicle is a second angle greater than the first specified angle.

According to an embodiment, a first movement distance of a specified finger of the user indicating the first gesture, which is identified when the driving speed of the vehicle is the first speed, is greater than a second movement distance of the specified finger of the user indicating the first gesture, which is identified when the driving speed of the vehicle is the second speed.

According to an embodiment, the wearable electronic device may identify the gaze of the user by using the camera.

According to an embodiment, the wearable electronic device may determine the at least one area, based on the gaze of the user.

According to an embodiment, the wearable electronic device may identify the first gesture, based on at least one of the movement direction or shape of a specific finger of the user.

According to an embodiment, the wearable electronic device may display information related to an autonomous driving of the vehicle in a specified area when the control device is configured in an autonomous driving mode of the vehicle.

According to an embodiment, an operating method of a wearable electronic device may include establishing a communication connection with a control device included in a vehicle.

According to an embodiment, the operating method of the wearable electronic device may include identifying a state of a user boarding the vehicle through a camera.

According to an embodiment, the operating method of the wearable electronic device may include identifying a driving state of the vehicle.

According to an embodiment, the operating method of the wearable electronic device may include determining at least one area for identifying a gesture of the user, based on at least one of the state of the user or the driving state.

According to an embodiment, the operating method of the wearable electronic device may include executing a first function corresponding to a first gesture among at least one function, based on identifying the first gesture of the user in the at least one area.

According to an embodiment, the operating method of the wearable electronic device may include identifying the state of the user, based on the position of the user in the vehicle.

According to an embodiment, the operating method of the wearable electronic device may include displaying at least one virtual object related to the at least one function, based on identifying that the left hand of the user is proximate to a first portion of a steering wheel of the vehicle.

According to an embodiment, the operating method of the wearable electronic device may include executing the first function, based on identifying the first gesture of the left hand with respect to the at least one virtual object in a first area proximate to the first portion among the at least one area.

According to an embodiment, the operating method of the wearable electronic device may include determining a first area corresponding to a position distanced from the steering wheel of the vehicle by a first specified distance among the at least one area, based on identifying that a driving speed of the vehicle is a first speed.

According to an embodiment, the operating method of the wearable electronic device may include determining a second area corresponding to a position distanced from the steering wheel of the vehicle by a second specified distance that is smaller than the first specified distance among the at least one area, based on identifying that the driving speed of the vehicle is a second speed greater than the first speed.

According to an embodiment, the operating method of the wearable electronic device may include displaying at least one virtual object related to the at least one function, based on identifying that one hand of the user is proximate to an armrest of the vehicle.

According to an embodiment, the operating method of the wearable electronic device may include displaying, based on identifying that the vehicle is being driven, at least one virtual object related to the at least one function when both hands of the user are proximate to the steering wheel of the vehicle.

According to an embodiment, the operating method of the wearable electronic device may include displaying, based on identifying that the vehicle is stopped, the at least one virtual object related to the at least one function even though both hands of the user are not proximate to the steering wheel of the vehicle.

According to an embodiment, the operating method of the wearable electronic device may include reducing the size of the at least one area as the driving speed increases.

According to an embodiment, the operating method of the wearable electronic device may include reducing the size of the at least one area as the rotation angle of the steering wheel of the vehicle increases.

According to an embodiment, the operating method of the wearable electronic device may include identifying the gaze of the user by using the camera.

According to an embodiment, the operating method of the wearable electronic device may include determining the at least one area, based on the gaze of the user.

According to an embodiment, the operating method of the wearable electronic device may include identifying the first gesture, based on at least one of the movement direction or shape of a specific finger of the user with respect to the at least one virtual object.

According to an embodiment, the operating method of the wearable electronic device may include displaying information related to an autonomous driving of the vehicle in a specified area when the control device is configured in an autonomous driving mode of the vehicle.

According to an embodiment, a non-transitory recording medium may include at least one instruction to execute an operation of establishing a communication connection with a control device included in a vehicle.

According to an embodiment, the non-transitory recording medium may include at least one instruction to execute an operation of identifying a state of a user boarding the vehicle through a camera.

According to an embodiment, the non-transitory recording medium may include at least one instruction to execute an operation of identifying a driving state of the vehicle.

According to an embodiment, the non-transitory recording medium may include at least one instruction to execute an operation of determining at least one area for identifying a gesture of the user, based on at least one of the state of the user or the driving state.

According to an embodiment, the non-transitory recording medium may include at least one instruction to execute an operation of executing a first function corresponding to a first gesture among at least one function, based on identifying the first gesture of the user in the at least one area.

According to an embodiment, the non-transitory recording medium may include at least one instruction to execute an operation of identifying the state of the user, based on the position of the user in the vehicle.

According to an embodiment, the non-transitory recording medium may include at least one instruction to execute an operation of displaying at least one virtual object related to the at least one function, based on identifying that one hand of the user is proximate to a first portion of a steering wheel of the vehicle.

According to an embodiment, the non-transitory recording medium may include at least one instruction to execute an operation of executing the first function, based on identifying the first gesture of the one hand with respect to the at least one virtual object in a first area proximate to the first portion among the at least one area.

According to an embodiment, the non-transitory recording medium may include at least one instruction to execute an operation of determining a first area corresponding to a position distanced from the steering wheel of the vehicle by a first specified distance among the at least one area, based on identifying that a driving speed of the vehicle is a first speed.

According to an embodiment, the non-transitory recording medium may include at least one instruction to execute an operation of determining a second area corresponding to a position distanced from the steering wheel of the vehicle by a second specified distance that is smaller than the first specified distance among the at least one area, based on identifying that the driving speed of the vehicle is a second speed greater than the first speed.

According to an embodiment, the non-transitory recording medium may include at least one instruction to execute an operation of displaying at least one virtual object related to the at least one function, based on identifying that one hand of the user is proximate to an armrest of the vehicle.

According to an embodiment, the non-transitory recording medium may include at least one instruction to execute an operation of displaying, based on identifying that the vehicle is being driven, at least one virtual object related to the at least one function when both hands of the user are proximate to the steering wheel of the vehicle.

According to an embodiment, the non-transitory recording medium may include at least one instruction to execute an operation of displaying, based on identifying that the vehicle is stopped, the at least one virtual object related to the at least one function even though both hands of the user are not proximate to the steering wheel of the vehicle.

According to an embodiment, the non-transitory recording medium may include at least one instruction to execute an operation of reducing the size of the at least one area as the driving speed increases.

According to an embodiment, the non-transitory recording medium may include at least one instruction to execute an operation of reducing the size of the at least one area as the rotation angle of the steering wheel of the vehicle increases.

According to an embodiment, the non-transitory recording medium may include at least one instruction to execute an operation of identifying the gaze of the user by using the camera.

According to an embodiment, the non-transitory recording medium may include at least one instruction to execute an operation of determining the at least one area, based on the gaze of the user.

According to an embodiment, the non-transitory recording medium may include at least one instruction to execute an operation of identifying the first gesture, based on at least one of the movement direction or shape of a specific finger of the user with respect to the at least one virtual object.

According to an embodiment, the non-transitory recording medium may include at least one instruction to execute an operation of displaying information related to an autonomous driving of the vehicle in a specified area when the control device is configured in an autonomous driving mode of the vehicle.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101, 200, 300, 501). For example, a processor (e.g., the processor 120, 420) of the machine (e.g., the electronic device 101, 200, 300, 501) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A wearable electronic device comprising:
a camera;
a display;
communication circuitry;
at least one processor; and
memory storing instructions that, when executed by the least one processor individually or collectively, cause the wearable electronic device to:
establish, through the communication circuitry, a communication connection with a control device included in a vehicle,
identify, through the camera, a state of a user in the vehicle,
identify a driving state of the vehicle,
based on at least one of the state of the user or the driving state, determine at least one area for identifying a gesture of the user, and
based on identifying a first gesture of the user in the at least one area, execute a first function corresponding to the first gesture among at least one function.

2. The wearable electronic device of claim 1, wherein the instructions that, when executed by the least one processor individually or collectively, cause the wearable electronic device to:
based on a position of the user in the vehicle, determine the state of the user.

3. The wearable electronic device of claim 1, wherein the instructions that, when executed by the least one processor individually or collectively, cause the wearable electronic device to:
based on identifying that one hand of the user is proximate to a first portion of a steering wheel of the vehicle, display at least one virtual object related to the at least one function, and
based on identifying the first gesture of the one hand in a first area proximate to the first portion among the at least one area, execute the first function.

4. The wearable electronic device of claim 1, wherein the instructions that, when executed by the least one processor individually or collectively, cause the wearable electronic device to:
based on identifying that a driving speed of the vehicle is a first speed, determine a first area corresponding to a position distanced from a steering wheel of the vehicle by a first specified distance among the at least one area, and
based on identifying that the driving speed of the vehicle is a second speed greater than the first speed, determine a second area corresponding to a position distanced from the steering wheel of the vehicle by a second specified distance that is smaller than the first specified distance among the at least one area.

5. The wearable electronic device of claim 1, wherein the instructions that, when executed by the least one processor individually or collectively, cause the wearable electronic device to:
based on identifying one hand of the user is proximate to an armrest of the vehicle, display at least one virtual object related to the at least one function.

6. The wearable electronic device of claim 1, wherein the instructions that, when executed by the least one processor individually or collectively, cause the wearable electronic device to:
based on identifying that the vehicle is in a driving state, display at least one virtual object related to the at least one function when both hands of the user are proximate to a steering wheel of the vehicle, and
based on identifying that the vehicle is stopped, display the at least one virtual object even if both hands of the user are not proximate to the steering wheel of the vehicle.

7. The wearable electronic device of claim 1, wherein the instructions that, when executed by the least one processor individually or collectively, cause the wearable electronic device to:
when identifying that a driving speed of the vehicle is a first speed less than or equal to a first specified speed, determine a size of the least one area as a first size, and
when identifying that the driving speed of the vehicle is a second speed greater than the first specified speed, determine the size of the least one area as a second size smaller than the first size.

8. The wearable electronic device of claim 1, wherein the instructions that, when executed by the least one processor individually or collectively, cause the wearable electronic device to:
when identifying that a rotation angle of a steering wheel of the vehicle is a first angle less than or equal to a first specified angle, determine a size of the at least one area as a first size, and
when identifying that the rotation angle of the steering wheel of the vehicle is a second angle greater than the first specified angle, determine the size of the at least one area as a second size smaller than the first size.

9. The wearable electronic device of claim 1,
wherein a first movement distance of a specified finger of the user indicating the first gesture, which is identified when a driving speed of the vehicle is a first speed, is greater than a second movement distance of the specified finger of the user indicating the first gesture, which is identified when the driving speed of the vehicle is a second speed.

10. The wearable electronic device of claim 1, wherein the instructions, when executed by the least one processor individually or collectively, cause the wearable electronic device to:
identify, using the camera, a gaze of the user, and
based on the gaze of the user, determine the at least one area.

11. The wearable electronic device of claim 1, wherein the instructions, when executed by the least one processor individually or collectively, cause the wearable electronic device to:
identify the first gesture based on at least one of a movement direction or a shape of a specific finger of the user.

12. The wearable electronic device of claim 1, wherein the instructions, when executed by the least one processor individually or collectively, cause the wearable electronic device to:
display information related to an autonomous driving of the vehicle in a specified area when the control device is set to an autonomous driving mode of the vehicle.

13. An operating method performed by a wearable electronic device, the method comprising:
establishing a communication connection with a control device included in a vehicle;
identifying a state of a user in the vehicle through a camera of the wearable electronic device;
identifying a driving state of the vehicle;
determining at least one area for identifying a gesture of the user, based on at least one of the state of the user or the driving state; and
executing a first function corresponding to a first gesture among at least one function, based on identifying the first gesture of the user in the at least one area.

14. The method of claim 13, further comprising identifying the state of the user, based on a position of the user in the vehicle.

15. The method of claim 13, further comprising:
displaying at least one virtual object related to the at least one function, based on identifying that one hand of the user is proximate to a first portion of a steering wheel of the vehicle; and
executing the first function, based on identifying the first gesture of the one hand in a first area proximate to the first portion among the at least one area.

16. The method of claim 13, wherein at least part of the determining of the at least one area comprises:
determining a first area corresponding to a position distanced from a steering wheel of the vehicle by a first specified distance among the at least one area, based on identifying that a driving speed of the vehicle is a first speed; and
determining a second area corresponding to a position distanced from the steering wheel of the vehicle by a second specified distance that is smaller than the first specified distance among the at least one area, based on identifying that the driving speed of the vehicle is a second speed greater than the first speed.

17. The method of claim 13, further comprising displaying at least one virtual object related to the at least one function, based on identifying that one hand of the user is proximate to an armrest of the vehicle.

18. The method of claim 13, further comprising:
displaying, based on identifying that the vehicle is being driven, at least one virtual object related to the at least one function when both hands of the user are proximate to a steering wheel of the vehicle; and
displaying, based on identifying that the vehicle is stopped, the at least one virtual object related to the at least one function even though both hands of the user are not proximate to the steering wheel of the vehicle.

19. The method of claim 13, further comprising reducing a size of the at least one area as a driving speed of the vehicle increases.

20. A storage medium storing computer-readable instructions, the instructions, when executed by at least one processor of a wearable electronic device, cause the wearable electronic device to perform operations, the operations comprising:
establishing a communication connection with a control device included in a vehicle;
identifying a state of a user in the vehicle through a camera of the wearable electronic device;
identifying a driving state of the vehicle;
determining at least one area for identifying a gesture of the user, based on at least one of the state of the user or the driving state; and
executing a first function corresponding to a first gesture among at least one function, based on identifying the first gesture of the user in the at least one area.
